(19) United States
(12) Patent Application Publication
(10) Pub. No.: US 2026/0269921 A1
(43) Pub. Date: Sep. 10, 2026

(54) GROUP-BASED BEAM REPORTING FOR SIMULTANEOUS MULTI-PANEL TRANSMISSION AND RECEPTION

(71) Applicant: Telefonaktiebolaget LM Ericsson (publ), Stockholm (SE)

(72) Inventors: Andreas Nilsson, Göteborg (SE); Shiwei Gao, Nepean (CA); Siva Muruganathan, Stittsville (CA)

(21) Appl. No.: 19/102,094

(22) PCT Filed: Jul. 25, 2023
(86) PCT No.: PCT/IB2023/057550

§ 371 Date: Feb. 7, 2025

Related U.S. Application Data
(60) Provisional application No. 63/396,039, filed on Aug. 8, 2022.

(51) Int. Cl. H04B 7/06; H04B 7/08

(52) U.S. Cl. CPC H04B 7/06956; H04B 7/0628; H04B 7/088

(57) ABSTRACT

Systems and methods for group-based beam reporting for simultaneous multi-panel transmission and reception are disclosed. In one embodiment, a method performed by a User Equipment (UE) comprises receiving, from a network node, a downlink reference signal configuration that configures a first and a second reference signal resource group, each comprising two or more reference signal resources. The method further comprises performing measurements on reference signals within reference signal resource groups and, based thereon, sending, to the network node, a group-based beam report comprising information for M beam groups. For each beam group, the information for the beam group indicates a first and a second reference signal resources from the first and second resource groups respectively wherein the first and second reference signals are associated with a first and second spatial filters respectively, and the first and second spatial filters can be used for simultaneous transmission, simultaneous reception, or both.

### RELATED APPLICATIONS

This application claims the benefit of provisional patent application Ser. No. 63/396,039, filed Aug. 8, 2022, the disclosure of which is hereby incorporated herein by reference in its entirety.

### TECHNICAL FIELD

The present disclosure relates to a cellular communications network and, more specifically, to beam reporting in a cellular communications network.

### BACKGROUND

### Beam Management

At millimeter-wave (mmW) frequencies, concepts for handling mobility between beams, both within and between Transmission and Reception Points (TRPs), have been specified in 3^{rd} Generation Partnership Project (3GPP) New Radio (NR). At these frequencies, where high-gain beamforming is used, each beam is only optimal within a small area, and the link budget outside the optimal beam deteriorates quickly. Hence, frequent and fast beam switching may be needed to maintain high performance. To support such beam switching, a beam indication framework has been specified in NR. For example, for downlink data transmission (i.e., Physical Downlink Shared Channel (PDSCH) transmission), the Downlink Control Information (DCI) contains a Transmission Configuration Indicator (TCI) field that informs the User Equipment (UE) which beam is used so that the UE can adjust its receive beam accordingly. This is beneficial for the case of analog receive (Rx) beamforming where the UE needs to determine and apply the Rx beamforming weights before it can receive the PDSCH.

As used herein, the terminology “spatial filtering weights” or “spatial filtering configuration” is used to refer to the antenna weights that are applied at either the transmitter (i.e., next generation Node B (gNB) for downlink or UE for uplink) and the receiver (i.e., UE for downlink or gNB for uplink) for data/control transmission/reception. This term is more general in the sense that different propagation environments lead to different spatial filtering weights that match the transmission/reception of a signal to the channel. The spatial filtering weights may not always result in a beam in a strict sense.

Prior to data transmission, a training phase is required to determine the gNB and UE spatial filtering configurations. This is illustrated in FIG. 1 and is referred to in NR as downlink (DL) beam management. In NR, two types of Reference Signals (RSs) are used for DL beam management operations, namely, the Channel State Information RS (CSI-RS) and the Synchronization Signal/Physical Broadcast Control Channel (SS/PBCH) block, or SSB for short. FIG. 1 shows an example where CSI-RS is used to find an appropriate beam pair link (BPL), meaning a suitable gNB transmit spatial filtering configuration (gNB transmit (Tx) beam) plus a suitable UE receive spatial filtering configuration (UE Rx beam) resulting in sufficiently good link budget. More specifically, FIG. 1 illustrates an example of the beam training phase followed by data transmission phase. For downlink data/control transmission, the gNB indicates to the UE that the Physical Downlink Control Channel (PDCCH)/PDSCH Demodulation RS (DMRS) is spatially quasi-co-located (QCL) with RS6—the RS on which the UE performs measurements during the UE beam sweep in the beam training phase. At least for uplink control channel transmission, the gNB indicates to the UE that RS6 is the spatial relation for PUCCH.

In the example of FIG. 1, in the gNB Tx beam sweep, the gNB configures the UE to measure on a set of five CSI-RS resources (RS1 . . . . RS5) which are transmitted with five different spatial filtering configurations (Tx beams). The UE is also configured to report back the RS Identifier (ID) and the Reference-Signal Receive Power (RSRP) of the CSI-RS corresponding to the maximum measured RSRP. In this example, the maximum measured RSRP corresponds to RS4. In this way, the gNB learns what is the preferred Tx beam from the UE perspective. In the subsequent UE Rx beam sweep, the gNB transmits a number of CSI-RS resources in different Orthogonal Frequency Division Multiplexing (OFDM) symbols all with the same spatial filtering configuration (Tx beam) as was used to transmit RS4 previously. The UE then tests a different Rx spatial filtering configuration (Rx beam) in each OFDM symbol to maximize the received RSRP. The UE remembers the RS ID (RS ID 6 in this example) and the corresponding spatial filtering configuration that results in the largest RSRP. The network can then refer to this RS ID in the future when DL data is scheduled to the UE, thus allowing the UE to adjust its Rx spatial filtering configuration (Rx beam) to receive the PDSCH. As mentioned above, the RS ID is contained in a Transmission Configuration Indicator (TCI) that is carried in a field in the DCI that schedules the PDSCH.

### Data Transmission Over Multiple Transmission Points (TRP) or Panels

A PDSCH may be transmitted to a UE from multiple TRPs. Since different TRPs may be located in different physical locations and have different beams, the propagation channels can be different. To facilitate receiving PDSCH data from different TRPs or beams, a UE may be configured by Radio Resource Control (RRC) with multiple TCI states. A TCI state contains Quasi Co-location (QCL) information between the DMRS for PDSCH and one or two DL reference signals such as Non-Zero Power (NZP) CSI-RS or SSB. Different NZP CSI-RSs or SSBs may be associated with different TRPs or beams. The QCL information can be used by a UE to apply large scale channel properties associated with the DL reference signals (NZP CSI-RS or SSB) to DMRS of PDSCH for channel estimation and PDSCH reception.

The supported QCL information types in NR are:

‘QCL-TypeA’: {Doppler shift, Doppler spread, average delay, delay
spread}
‘QCL-TypeB’: {Doppler shift, Doppler spread}
‘QCL-TypeC’: {Doppler shift, average delay}
‘QCL-TypeD’: {Spatial Rx parameter}

A subset of the RRC configured TCI states may be activated by Medium Access Control (MAC) Control Element (CE) for PDSCH. From the activated TCI states, one or two of them may be dynamically selected and indicated in the DCI scheduling a PDSCH depending on over which TRP(s) or beam(s) the PDSCH is transmitted. Each codepoint of the TCI field in DCI can indicate either one TCI state or two TCI states. A TCI field codepoint indicating one TCI state can be used to transmit PDSCH from a single TRP or single beam. If a TCI field codepoint indicates two TCI states, then PDSCH can be transmitted from two TRPs or two beams.

### Group-Based Beam Reporting in NR

Simultaneous multi-TRP transmission with multi-panel reception can enable Non-Coherent Joint-Transmission (NC-JT) in Frequency Range 2 (FR2). An example is shown in FIG. 2, where a PDSCH is sent to a UE over two TRPs, with each TRP transmitting two layers. In this case, by transmitting PDSCH over two TRPs to the UE, the peak data rate to the UE can be increased as up to four aggregated layers from the two TRPs can be received by the UE.

In NR Rel-15, when a UE is configured with higher layer parameter groupBasedBeamReporting set to ‘enabled’, the UE will report either two different CSI-RS Resource Indicators (CRIs) or two different SS/PBCH Resource Indicators (SSBRIs) in a single reporting instance for each report setting. The two CRIs or two SSBRIs are chosen such that the corresponding CSI-RS and/or SSB resources can be received simultaneously by the UE.

FIG. 3 shows an example scenario illustrating simultaneous multi-TRP transmission with multi-panel reception at the UE. In this example, NZP CSI-RS resources #1 and #2 are transmitted from TRP1 and NZP CSI-RS resources #3 and #4 are transmitted from TRP2. The UE is equipped with two panels.

In the example of FIG. 3, if the UE uses the existing group-based beam reporting in NR (i.e., when groupBasedBeamReporting is enabled), the UE may choose the two CRIs to be reported in one of the following ways:
Case 1: both CRIs correspond to TRP1 (e.g., NZP CSI-RS resources #1 and #2 are chosen by the UE).
Case 2: both CRIs correspond to TRP2 (e.g., NZP CSI-RS resources #3 and #4 are chosen by the UE)
Case 3: one CRI corresponds to TRP1 and the other CRI corresponds to TRP2 (e.g., NZP CSI-RS resources #1 and #3)

If UE reports the two CRIs according to either Case 1 or Case 2, then both beams reported correspond to the same TRP. In Cases 1 and 2, simultaneous multi-TRP transmission is not possible. Case 3 allows simultaneous multi-TRP transmission as the two beams reported correspond to different TRPs.

To handle this issue, group-based beam reporting was enhanced in NR Rel-17, where the UE can be configured to report in a single CSI-report N beam groups (where N is RRC configured and can be up to Nmax, where Nmax={1,2,3,4} is a UE capability), where each beam group consists of two beams (i.e. two SSBRI/CRI values and corresponding L1-RSRP), and where the two beams can be received simultaneously by the UE. To make sure that each beam in a beam group is associated to different TRPs, the UE can be configured with two Channel Measurement Resource (CMR) sets, where each CMR set is associated to one TRP, and where the UE selects one CMR (i.e., one SSBRI/CRI) from each CMR set in each beam group. For periodic/semi-persistent CMRs, two CMR resource sets are configured per periodic/semi-persistent CMR resource setting. For aperiodic CMR, the existing RRC parameter CSI-AssociatedReportConfigInfo is extended to be configured with two CMR resource sets.

When gNB configures UE to report Rel-17 group-based beam reporting, the supported report format is shown in Table 1 [see, e.g., 3GPP TS 38.212]. In the table, the 1-bit Resource set indicator, is used to indicate if the strongest beam (i.e., CRI or SSBRI #1 of 1st resource group) belongs to the 1st or the 2nd CMR set. Absolute RSRP (7 bits) is reported for the strongest beam, and differential RSRP (4 bits) is reported for the remaining beams. The bitwidth of each SSBRI/CRI is determined based on the number of SSB/CSI-RS resources in the associated CMR resource set.

TABLE 1
Supported report format of Rel-17 group-based beam reporting

| CSI report | |
|---|---|
| number | CSI fields |
| CSI report | Resource set indicator |
| #n | CRI or SSBRI #1 of 1st resource group |
| | CRI or SSBRI #2 of 1st resource group |
| | CRI or SSBRI #1 of 2nd resource group |
| | CRI or SSBRI #2 of 2nd resource group |
| | CRI or SSBRI #1 of 3rd resource group |
| | CRI or SSBRI #2 of 3rd resource group |
| | CRI or SSBRI #1 of 4th resource group |
| | CRI or SSBRI #2 of 4th resource group |
| | RSRP of CRI or SSBRI #1 of 1st resource group |
| | Differential RSRP of CRI or SSBRI #2 of 1st resource group |
| | Differential RSRP of CRI or SSBRI #1 of 2nd resource group |
| | Differential RSRP of CRI or SSBRI #2 of 2nd resource group |
| | Differential RSRP of CRI or SSBRI #1 of 3rd resource group |
| | Differential RSRP of CRI or SSBRI #2 of 3rd resource group |
| | Differential RSRP of CRI or SSBRI #1 of 4th resource group |
| | Differential RSRP of CRI or SSBRI #2 of 4th resource group |

### Simultaneous Multi-Panel Transmission (STxMP)

In NR up to Rel-17, the discussions regarding uplink (UL) transmission for Frequency Range 2 (FR2) has mainly been for a UE with single panel transmission, i.e., transmission from a single UE panel at each time instance. In NR-Rel 18, it has been agreed to study, and if needed specify support for, up to two simultaneously transmitting UE panels. A UE panel may be a set of antenna elements, wherein separate UE panels can be used for separate Tx or Rx beams at the UE. In the first Rel-18 3GPP meeting (RAN1 #109-e), it was agreed that several candidate single-DCI UL multi-panel transmission schemes should be considered, as can been seen from the agreements below:

For STxMP PUSCH in single-DCI based mTRP system, study and evaluate the following schemes for PUSCH:
SDM scheme: different layers/DMRS ports of one PUSCH are separately precoded and transmitted from different UE panels simultaneously.
   Study and evaluate whether to support 2 CWs in SDM manner and transmitted from two different panel simultaneously.
FDM-B scheme: two PUSCH transmission occasions with same/different RV of the same TB are transmitted from different UE panels on non-overlapped frequency domain resources and the same time domain resources.
FDM-A scheme: different parts of the frequency domain resource of one PUSCH transmission occasion are transmitted from different UE panels.
SFN-based transmission scheme: all of the same layers/DMRS ports of one PUSCH are transmitted from two different UE panels simultaneously.
SDM repetition scheme: two PUSCH transmission occasions with different RV of the same TB are transmitted from two different UE panels simultaneously.

### SUMMARY

Systems and methods for group-based beam reporting for simultaneous multi-panel transmission and reception are disclosed. In one embodiment, a method performed by a User Equipment (UE) comprises receiving, from a network node, a downlink reference signal configuration that configures a first and a second reference signal resource group, wherein each reference signal resource group of the first and the second reference signal resource groups comprises two or more reference signal resources. The method further comprises performing measurements on reference signals within the first and the second reference signal resource groups. The method further comprises, based on the measurements, sending, to the network node, a group-based beam report comprising information for M beam groups. For each beam group of the M beam groups, the information for the beam group indicates a first reference signal resource from the first resource group and a second reference signal resource from the second resource group wherein the first reference signal is associated with a first spatial filter and the second reference signal is associated with a second spatial filter, and the first and the second spatial filters can be used for simultaneous transmission, simultaneous reception, or both simultaneous transmission and simultaneous reception. In this manner, the network is enabled to determine if beams reported from the UE during a beam management procedure can be used for simultaneous multi-panel UL transmission or not.

In one embodiment, the first spatial filter is associated with a first UE panel, and the second spatial filter is associated with a second UE panel.

In one embodiment, the method further comprises receiving, from the network node, a report configuration associated to the downlink reference signal configuration, the report configuration comprising a field that indicates that the UE is to perform group-based beam reporting for Simultaneous Multi-Panel Transmission (STxMP). Responsive to the field that indicates that the UE is to perform group-based beam reporting for STxMP, the UE assumes that, for each beam group of the M beam groups, the UE is to only include the first and the second reference signal resources that are respectively associated with the first and the second spatial filters that can be used for simultaneous transmission.

In one embodiment, the method further comprises receiving, from the network node, a report configuration associated to the downlink reference signal configuration, the report configuration comprising a field that indicates that the UE is to perform group-based beam reporting for STxMP. Responsive to the field that indicates that the UE is to perform group-based beam reporting for STxMP, for each beam group of the M beam groups, the first and the second spatial filters used respectively for the first and the second reference signal resources indicated by the beam group can be used for simultaneous transmission.

In one embodiment, the method further comprises receiving, from the network node, a report configuration associated to the downlink reference signal configuration, the report configuration comprising a field that indicates that the UE is to perform group-based beam reporting for STxMP. Responsive to the field that indicates that the UE is to perform group-based beam reporting for STxMP, the UE assumes that, for each beam group of the M beam groups, the UE is to only include the first and the second reference signal resources that are respectively associated with the first and the second spatial filters that can be used for both simultaneous transmission and simultaneous reception.

In one embodiment, the method further comprises receiving, from the network node, a report configuration associated to the downlink reference signal configuration, the report configuration comprising a field that indicates that the UE is to perform group-based beam reporting for STxMP. Responsive to the field that indicates that the UE is to perform group-based beam reporting for STxMP, for each beam group of the M beam groups, the first and the second spatial filters used respectively for the first and the second reference signal resources indicated by the beam group can be used for both simultaneous transmission and simultaneous reception.

In one embodiment, the method further comprises transmitting, to the network node, capability information that comprises an indication that the UE supports group-based beam reporting for simultaneous multi-panel uplink transmission.

In one embodiment, the capability information further comprises: (a) information that indicates a number of UE panels at the UE, (b) information that indicates which UE panels can be used for simultaneous uplink transmission, (c) information that indicates which UE panels can be used for simultaneous downlink reception, (d) information that indicates which UE panels can be used for simultaneous uplink transmission and simultaneous downlink reception, or (e) a combination of any two or more of (a)-(c).

In one embodiment, the capability information further comprises, for each UE panel of the two or more UE panels of the UE: (a) information that indicates which other UE panel(s) can be used together with the UE panel for simultaneous uplink transmission, (b) information that indicates which other UE panel(s) can be used together with the UE panel for simultaneous downlink reception, (c) information that indicates which other UE panel(s) can be used together with the UE panel for simultaneous uplink transmission and simultaneous downlink reception, or (d) a combination of any two or more of (a)-(c).

In one embodiment, the capability information comprises a bitfield that indicates which UE panels can be used for simultaneous uplink transmission and/or simultaneous downlink reception, wherein each bit of the bitfield is associated with a set of UE panels.

In one embodiment, the method further comprises receiving, from the network node, a report configuration associated to the downlink reference signal configuration. In one embodiment, the report configuration comprises a report setting field. In one embodiment, the report configuration indicates that the UE is to perform group-based beam reporting for STxMP.

In one embodiment, for a reference signal resource group from among the first and the second reference signal resource groups, the report configuration comprises an indication that the UE is to use the first spatial filter when receiving the first reference signal in the first reference signal resource group, and the second spatial filter when receiving the second reference signal in the second reference signal resource group.

In another embodiment, for a reference signal resource group from among the first and the second reference signal resource groups, the report configuration comprises an indication that the UE is to use the first spatial filter when receiving the first reference signal in the first reference signal resource group, and the second spatial filter when receiving the second reference signal in the second reference signal resource group, and where the first and second spatial filters are not associated with a same UE panel.

In another embodiment, for a reference signal resource group from among the first and the second reference signal resource groups, the report configuration comprises an indication that the UE is to use the first spatial filter when receiving the first reference signal in the first reference signal resource group, and the second spatial filter when receiving the second reference signal in the second reference signal resource group, and where the first and second spatial filters are associated with to different UE panels and where the two different UE panels can be used for simultaneous transmission.

In another embodiment, the report configuration comprises information that configures the UE to include, in the group-based beam report, an indication of the UE panel associated with each reference signal resource reported in each of the M beam groups.

In another embodiment, the report configuration comprises an indication that the UE is to report information that indicates whether a first UE panel associated with the first reported reference signal resource in a reported beam group and a second UE panel associated with the second reported reference signal resource in the same reported beam group can be used for simultaneous transmission or not.

In another embodiment, the report configuration comprises an indication that the UE is to report information that indicates whether a first UE panel associated with the first reported reference signal resource in a reported beam group and a second UE panel associated with the second reported reference signal resource in the same reported beam group can be used for simultaneous transmission, simultaneous reception, both simultaneous transmission and simultaneous reception, or neither simultaneous transmission nor simultaneous transmission.

In another embodiment, the report configuration comprises an indication of which of multiple candidate options that the UE should assume for the group-based beam report. In one embodiment, the multiple candidate options comprise: (a) UE panels associated to the spatial filters used for the reference signal resources indicated by the same beam group can be used for simultaneous transmission, (b) UE panels associated to the spatial filters used for the reference signal resources indicated by the same beam group can be used for simultaneous reception, or (c) UE panels associated to the spatial filters used for the reference signal resources indicated by the same beam group can be used for both simultaneous UL transmission and simultaneous DL reception.

In one embodiment, the method further comprises receiving a trigger message that initiates the performing of the measurements in accordance with the report configuration.

In one embodiment, the group-based beam report further comprises a performance metric for each reported reference signal resource for each of the M beam groups. In one embodiment, the performance metric indicates uplink performance. In another embodiment, the performance metric indicates downlink reference signal received power plus an uplink power factor. In one embodiment, the uplink power factor is associated with the UE panel that was used to receive the associated reference signal. In one embodiment, the uplink power factor considers either or both of: (i) Power Management Maximum Power Reduction (P-MPR) associated with the UE panel and (ii) maximum available output power associated with the UE panel.

In one embodiment, the group-based beam report further comprises information that indicates the UE panel associated with each reported reference signal resource for each of the M beam groups.

In one embodiment, the group-based beam report further comprises, for each reported set of reference signal resources for each of the M beam groups, information that indicates that different spatial filters were used for reception of associated reference signals for each of the set of reference signal resources.

In one embodiment, the report further comprises, for each reported set of reference signal resources for each of the M beam groups, information that indicates that different spatial filters were used for reception of associated reference signals for each of the set of reference signal resources and the associated UE panels can be used for simultaneous uplink transmission.

In one embodiment, the report further comprises, for each reported set of reference signal resources for each of the M beam groups, information that indicates that different spatial filters were used for reception of associated reference signals for each of the set of reference signal resources and the associated UE panels can be used for simultaneous downlink reception.

Corresponding embodiments of a UE are also disclosed. In one embodiment, a UE is adapted to receive, from a network node, a downlink reference signal configuration that configures a first and a second reference signal resource group, wherein each reference signal resource group of the first and the second reference signal resource groups comprises two or more reference signal resources. The UE is further adapted to perform measurements on reference signals within the first and the second reference signal resource groups. The UE is further adapted to, based on the measurements, send, to the network node, a group-based beam report comprising information for M beam groups. For each beam group of the M beam groups, the information for the beam group indicates a first reference signal resource from the first resource group and a second reference signal resource from the second resource group wherein the first reference signal is associated with a first spatial filter and the second reference signal is associated with a second spatial filter, and the first and the second spatial filters can be used for simultaneous transmission, simultaneous reception, or both simultaneous transmission and simultaneous reception.

In one embodiment, a UE comprises a communication interface and processing circuitry associated with the communication interface. The processing circuitry is configured to cause the UE to receive, from a network node, a downlink reference signal configuration that configures a first and a second reference signal resource group, wherein each reference signal resource group of the first and the second reference signal resource groups comprises two or more reference signal resources. The processing circuitry is further configured to cause the UE to perform measurements on reference signals within the first and the second reference signal resource groups. The processing circuitry is further configured to cause the UE to, based on the measurements, send, to the network node, a group-based beam report comprising information for M beam groups. For each beam group of the M beam groups, the information for the beam group indicates a first reference signal resource from the first resource group and a second reference signal resource from the second resource group wherein the first reference signal is associated with a first spatial filter and the second reference signal is associated with a second spatial filter, and the first and the second spatial filters can be used for simultaneous transmission, simultaneous reception, or both simultaneous transmission and simultaneous reception.

Embodiments of a method performed by a network node are also disclosed. In one embodiment, a method performed by a network node comprises sending, to a UE, a downlink reference signal configuration that configures a first and a second reference signal resource group, wherein each reference signal resource group of the first and the second reference signal resource groups comprises two or more reference signal resources. The method further comprises receiving, from the UE, a group-based beam report comprising information for M beam groups. For each beam group of the M beam groups, the information for the beam group indicates a first reference signal resource from the first resource group and a second reference signal resource from the second resource group wherein the first reference signal is associated with a first spatial filter and the second reference signal is associated with a second spatial filter, and the first and the second spatial filters can be used for simultaneous transmission, simultaneous reception, or both simultaneous transmission and simultaneous reception.

Corresponding embodiments of a network node are also disclosed. In one embodiment, a network node is adapted to send, to a UE, a downlink reference signal configuration that configures a first and a second reference signal resource group, wherein each reference signal resource group of the first and the second reference signal resource groups comprises two or more reference signal resources. The network node is further adapted to receive, from the UE, a group-based beam report comprising information for M beam groups. For each beam group of the M beam groups, the information for the beam group indicates a first reference signal resource from the first resource group and a second reference signal resource from the second resource group wherein the first reference signal is associated with a first spatial filter and the second reference signal is associated with a second spatial filter, and the first and the second spatial filters can be used for simultaneous transmission, simultaneous reception, or both simultaneous transmission and simultaneous reception.

In one embodiment, a network node comprises a communication interface and processing circuitry associated with the communication interface. The processing circuitry is configured to cause the network node to send, to a UE, a downlink reference signal configuration that configures a first and a second reference signal resource group, wherein each reference signal resource group of the first and the second reference signal resource groups comprises two or more reference signal resources. The processing circuitry is further configured to cause the network node to receive, from the UE, a group-based beam report comprising information for M beam groups. For each beam group of the M beam groups, the information for the beam group indicates a first reference signal resource from the first resource group and a second reference signal resource from the second resource group wherein the first reference signal is associated with a first spatial filter and the second reference signal is associated with a second spatial filter, and the first and the second spatial filters can be used for simultaneous transmission, simultaneous reception, or both simultaneous transmission and simultaneous reception.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates New Radio (NR) downlink (DL) beam management.

FIG. 2 illustrates an example of Non-Coherent Joint Transmission (NC-JT) enabled by simultaneous multi-Transmission and Reception Point (TRP) transmission with multi-panel reception.

FIG. 3 shows an example scenario illustrating simultaneous multi-TRP transmission with multi-panel reception at the User Equipment (UE).

FIG. 4 illustrates an example of a switching transmit (TX)/receive (RX) patent switching network.

FIG. 5 illustrates one embodiment of the present disclosure, where a new field (“groupBasedBeamReporting-STxMP”) is introduced in Report setting (CSI-ReportConfig Information Element (IE) as specified in 3GPP Technical Specification (TS) 38.331, see, e.g., V17.0.0).

FIG. 6 illustrates an embodiment in which a UE can be configured to consider either downlink (DL) simultaneous reception (“DL only”), simultaneous uplink (UL) transmission (“UL only”), or both simultaneous DL reception and simultaneous UL transmission (DL_and_UL) for the reported beams in each beam pair (or beam group).

FIG. 7 illustrates an embodiment in which a UE can be configured to consider whether the two (or the plurality of) beams in a beam pair (or beam group) are received with different or the same UE panels.

FIG. 8 illustrates an embodiment in which a UE can be configured to consider whether the two (or more) beams in a beam pair (or beam group) can be transmitted simultaneously.

FIG. 9 illustrates an example embodiment in which a parameter “simultaneous-Tx” is introduced in field “groupBasedBeamReporting-v1710” as specified in 3^{rd} Generation Partnership Project (3GPP) Technical Specification (TS) 38.331 and used to indicate the Rel-17 group based beam reporting for the UE.

FIG. 10 illustrates an example in which a UE during UE capability signaling indicates which UE panels that can be used for simultaneous UL transmission and/or simultaneous DL reception.

FIG. 11 illustrates an example embodiment in which a single bitfield is used to indicate which UE panels (UE capability value sets) that can be used for simultaneous UL transmission and/or DL reception.

FIG. 12 illustrates an example embodiment in which more than two reference signal resource sets may be configured to the UE where the more than two reference signal resource sets correspond to more than two TRPs or more than two UE panels. Each reference signal resource set contains a plurality of reference signals corresponding to a plurality of beams. When reporting Channel State Information Reference Signal (CSI-RS) Resource Indicators (CRIs) or Synchronization Signal Block (SSB) Resource Indicators (SSBRIs) in a beam group, the corresponding reference signal resource set Identifier (ID) is reported by the UE for each reported CRI or SSBRI in a beam group.

FIG. 13 illustrates an example embodiment where there are two TRPs and a UE equipped with three UE panels.

FIG. 14 illustrates example signaling between a UE and the network for embodiments related to reporting associated Sounding Reference Signal (SRS) resource.

FIG. 15 illustrates the operation of a UE and a network node in accordance with at least some of the embodiments described herein.

FIG. 16 illustrates an example of a communication system in accordance with some embodiments.

FIG. 17 shows a UE in accordance with some embodiments.

FIG. 18 shows a network node in accordance with some embodiments.

FIG. 19 is a block diagram of a host, which may be an embodiment of the host of FIG. 16, in accordance with various aspects described herein.

FIG. 20 is a block diagram illustrating a virtualization environment in which functions implemented by some embodiments may be virtualized.

FIG. 21 shows a communication diagram of a host communicating via a network node with a UE over a partially wireless connection in accordance with some embodiments.

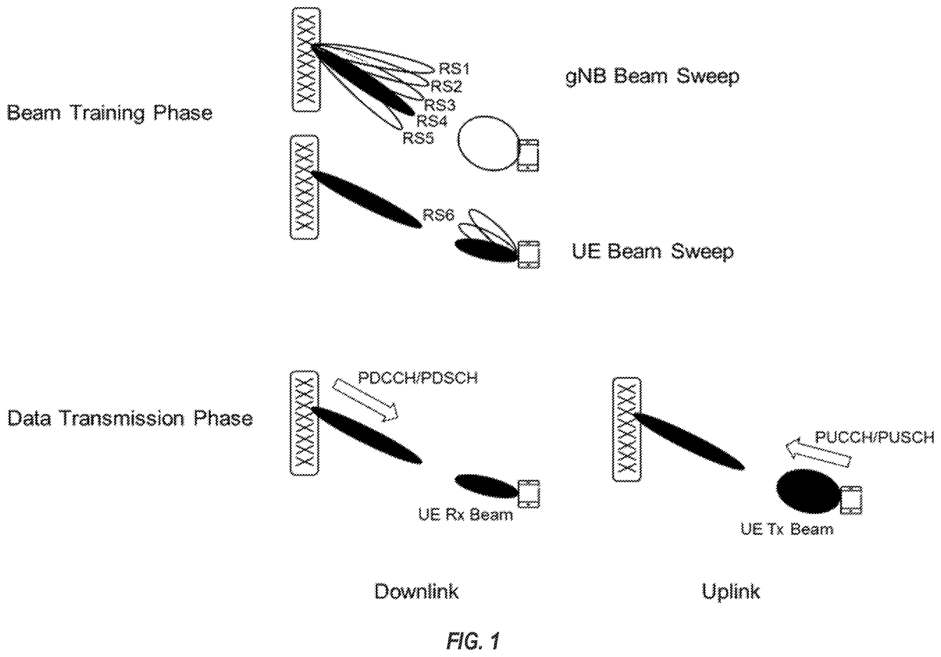

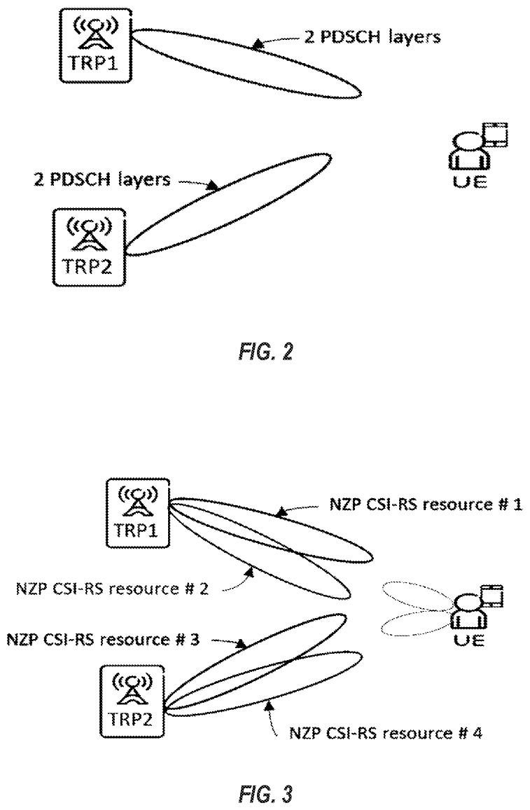

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

In this disclosure, the term “beam” is used which may be represented by uplink spatial filtering coefficients/configuration, downlink spatial filtering coefficients/configuration, or both uplink and downlink spatial filtering coefficients/configurations. When a beam is reported by the User Equipment (UE), the UE may report a reference signal index that represents the beam (i.e., the UE uses the beam to receive or transmit the reference signal corresponding to the reference signal index). The reference signal can be either Channel State Information Reference Signal (CSI-RS), in which case the UE reports a CSI-RS Resource Index (CRI), or a Synchronization Signal Block (SSB), in which case the UE reports a SSB Resource Index (SSBRI).

Note that a “UE panel” can be represented by Sounding Reference Signal (SRS) resource set ID or SRS resource ID.

There currently exist certain challenge(s). In 3rd Generation Partnership Project (3GPP) New Radio (NR) Rel-18, it has been agreed to specify support for simultaneous multi-panel uplink (UL) transmissions. In addition, the focus on multi-panel/multi-Transmission and Reception Point (TRP)/Distributed Multiple-Input Multiple-Output (D-MIMO) transmission schemes are expected to increase even further for Fifth Generation (5G) Advance and Sixth Generation (6G); hence, this is an area that most likely will be considered for later releases of NR and/or 6G in case it is not specified in Rel-18. In 6G where D-MIMO is expected to happen and a UE might be connected to more than two TRPs, simultaneous UL transmission from more than two UE panels might become specified (for example up to four UE panels). How to perform and report beams to enable simultaneous UL multi-panel transmission with up to four UE panels is an open issue.

One issue with simultaneous multi-panel UL transmission is that the network might not know which UE panels can be used for simultaneous transmission and which panels cannot be used for simultaneous transmission. In the current NR specification, the network can configure the UE with a group-based beam reporting, where the UE reports a pair of beams that can be received simultaneously by the UE. However, it is currently not possible for the network to know if the reported pair of beams can be received with a same or different UE panels, and, if the beams can be received with different UE panels, whether the UE can simultaneously transmit from the two UE panels or not.

Since the number of transmit (TX) chains and receive (RX) chains could be different for different UEs and have different circuit designs (including different TX/RX switching circuits), even if the network manages to determine which UE panels can receive simultaneously, the network may not know which UE panels can transmit simultaneously.

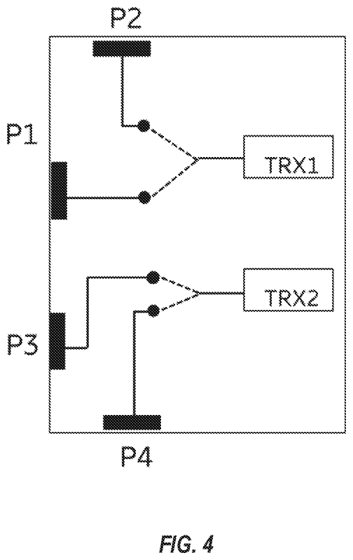

Another related issue is that, depending on the TX/RX panel switching network of a UE, the UE panels that can be used for simultaneous multi-panel transmission or simultaneous multi-panel reception could be different for different UEs. One example of what a switching TX/RX panel switching network can look like is schematically illustrated in FIG. 4. In the example of FIG. 4, UE panel P1 cannot be used for simultaneous downlink (DL)/UL transmission/reception with UE panel P2, and in the same way UE panel P3 cannot be used for simultaneous DL/UL transmission/reception with UE panel P4. All other UE panel combinations support simultaneous DL/UL transmission/reception. In this example, the same number of receiver chains and transmitter chains is used, and the same antenna switching network is used for both the transmitter side and the receiver side. However, this may not always be the case. For example, a UE may be able to receive on 3 or 4 UE panels simultaneously while only being able to transmit on one or two UE panels simultaneously.

Certain aspects of the disclosure and their embodiments may provide solutions to the aforementioned and/or other challenges. Systems and methods are disclosed herein that enable a UE to indicate in a beam report if up to four reported beams in a beam group can be used for simultaneous DL reception and/or simultaneous UL transmission. Note that while the example embodiments disclosed herein mostly focus on the example where there is up to four reported beams in a beam group, the number of reported beams in a beam group alternatively be up to N, where N is greater than or equal to 4.

Some example embodiments of the present disclosure are as follows. Note, however, that all embodiments disclosed herein are not captured in the following examples.

Embodiment 1: A method in a user device (UE) for reporting beams targeting simultaneous multi-panel uplink transmission, the method comprising at least one of the following steps:
a. transmitting a capability to the network node indicating support for group-based beam reporting for simultaneous multi-panel uplink transmission
b. receiving a message containing a field DL reference signal configuration, wherein the DL reference signal configuration configures two (or more) groups of reference signal resources
c. receiving a message containing a field Channel State Information (CSI) report configuration, wherein the CSI report configuration is associated with the DL reference signal configuration; and
d. (Optional) receiving a trigger message to measure according to the CSI Report configuration; and
e. perform the measurements on reference signals on reference signal resources in two or more groups of reference signal resources, where each reference signal is received with a spatial filter, and where each spatial filter is associated with a UE panel (e.g., virtual UE panel ID, UE capability value set)
f. report M beam groups, where each beam group contains information that indicates one reference signal resource from each of a subset or the whole set of reference signal groups, and where the UE panels associated to the spatial filters used to receive the reference signals on the indicated reference signal resources in a beam group can be one of:
   i. used for simultaneous (e.g., uplink) transmission
   ii. used for simultaneous (e.g., downlink) reception, or
   iii. used for both simultaneous transmission and simultaneous reception.

Embodiment 2: The method of embodiment 1 and where the network node indicating support for group-based beam reporting for simultaneous multi-panel uplink transmission (1a), the capability can in addition indicate one or more of the following
a. Number of UE panels (UE capability value sets)
b. Indication of which UE panels (UE capability value sets) that can be used for simultaneous UL transmissions
c. Indication of which UE panels (UE capability value sets) that can be used simultaneous DL reception.

Embodiment 3: The method of embodiment 2 and where a field per UE panel (UE capability value set) indicates which other UE panels (UE capability value sets) that can be used for simultaneous UL transmission and/or DL reception with that UE panel.

Embodiment 4: The method of embodiment 2 and where a single bitfield is used to indicate which UE panels (UE capability value set) can be used for simultaneous UL. transmission and/or DL reception, and where each bit of the bitfield is associated with a pair of UE panels (UE capability value set) (for example, the first bit is associated with UE panel 1 and UE panel 2, second bit is associated with UE panel 1 and UE panel 3 and so on).

Embodiment 5: The method of embodiment 1 and where the CSI Report configuration contain a field Report setting.

Embodiment 6: The method of embodiment 1,5 and where a field in the Report setting is used to indicates that the UE should perform group-based beam reporting for Simultaneous Multi-Panel Transmission (STxMP).

Embodiment 7: The method of embodiment 5,6 and where a field is configured in the Report setting to indicate that the UE should use a first spatial filter when receiving the first reference signal in a reported pair of reference signals, and a second spatial filter when receiving the second reference signal in the same reported pair of reference signals, and where the first and second spatial filter could be associated with the same or different UE panels (UE capability value set).

Embodiment 8: The method of embodiment 5,6 and where a field is configured in the Report setting to indicate that the UE should use a first spatial filter when receiving the first reference signal in a reported pair of reference signals, and a second spatial filter when receiving the second reference signal in the same reported pair of reference signals, and where the first and second spatial filter should not be associated with the same UE panel (UE capability value set).

Embodiment 9: The method of embodiment 5,6 and where a field is configured in the Report setting to indicate that the UE should use a first spatial filter when receiving the first reference signal in a reported pair of reference signals, and a second spatial filter when receiving the second reference signal in the same reported pair of reference signals, and where the first and second spatial filter should not be associated with the same UE panel (UE capability value set) and where the two different UE panels can be used for simultaneous transmission.

Embodiment 10. 5,6 and where a field is configured in the Report setting to indicate that the UE should include in a report the UE panel (UE panel ID, virtual UE panel ID, UE capability values set) associated with each of the two reported reference signals in a reported pair of reference signals.

Embodiment 11: The method of embodiment 5,6 and where a field is configured in the Report setting to indicate that the UE should report if a first UE panel (UE capability value sets), associated with a first reported reference signal in a reported pair of reference signals, and a second UE panel, associated with a second reported reference signal in the same reported pair of reference signals, can be used for simultaneous UL transmission or not.

Embodiment 12: The method of embodiment 5,6 and where a field is configured in the Report setting to indicate that the UE should report if a first UE panel (UE capability value sets), associated with a first reported reference signal in a reported pair of reference signals, and a second UE panel, associated with a second reported reference signal in the same reported pair of reference signals, can be used for simultaneous UL transmission, simultaneous DL reception, both simultaneous UL transmission and simultaneous DL reception, or neither simultaneous UL transmission nor simultaneous DL transmission.

Embodiment 13: The method of embodiment 5,6 and where a field is configured in the Report setting to indicate which of the three candidate options (1f) that the UE should assume for the report, i.e. the UE can be configured to follow one of:
a. the beams in a group of the report can be used for simultaneous UL transmission
b. the beams in a group of the report can be used for simultaneous DL reception
c. the beams in a group of the report can be used for both simultaneous UL transmission and simultaneous DL reception.

Embodiment 14: The method of embodiment 1 and where the UE includes in the report (1f) a performance metric for each of the reported reference signals.

Embodiment 15: The method of embodiment 14 and where the performance metric indicates UL performance.

Embodiment 16: The method of embodiment 15 and where the performance metric indicates DL RSRP+UL power factor per reference signal.

Embodiment 17: The method of embodiment 16 and where the UL power factor is associated with the UE panel (UE capability values set) that was used to receive the associated reference signal.

Embodiment 18: The method of embodiment 17 and where the UL power factor consider one or more of
a. Power Management Maximum Power Reduction (P-MPR) associated with the UE panel
b. Maximum available output power associated with the UE panel.

Embodiment 19: The method of embodiment 1 and where the UE includes in the report (1f) a UE panel (UE capability values set) associated with each reported reference signal.

Embodiment 20: The method of embodiment 1 and where the UE includes a field in the report (1f) associated with each reported pair of reference signals, where the field indicates that a first spatial filter used to receive the first reference signal of the pair of reference signals is associated with a different UE panel than a second spatial filter used to receive the second reference signal of the pair of reference signals.

Embodiment 21: The method of embodiment 1 and where the UE includes a field in the report (1f) associated with each reported pair of reference signals, where the field indicates that a first spatial filter used to receive the first reference signal of the pair of reference signals is associated with a different UE panel than a second spatial filter used to receive the second reference signal of the pair of reference signals, and where the two UE panels can be used for simultaneous UL transmission.

Embodiment 22: The method of embodiment 1 and where the UE includes a field in the report (1f) associated with each reported pair of reference signals, where the field indicates that a first spatial filter used to receive the first reference signal of the pair of reference signals is associated with a different UE panel than a second spatial filter used to receive the second reference signal of the pair of reference signals, and where the two UE panels can be used for simultaneous DL transmission.

Note that even though the example embodiments described herein focus on support of simultaneous transmission from two UE panels to up to two different TRPs, several embodiments are also disclosed herein related to extending the solution(s) described herein with simultaneous transmission from up to 4 UE panels and up to 4 TRPs.

Note that the beam report referred to herein is called “group-based beam reporting”. However, in 6G the report might be called something else. The embodiments disclosed herein are applicable to any kind of beam report that indicates that a group of reported beams can be used for simultaneous UL transmission.

Note that while the term “UE panel” or “UE capability value set” is used herein, in 6G a UE panel can be denoted by other things, like for example an explicit UE panel ID (associated with a certain physical UE panel), virtual UE panel ID (not explicitly associated with a physical UE panel, i.e. the UE can itself make the association between a virtual UE panel ID and a physical UE panel), some other UE panel related RRC field etc. Note that the naming might be different compared to the ones exemplified here.

Note that we have used the word “Report setting” in the description provided herein; however, it might be called something else in 6G. When we say “Report setting”, we generally mean a Radio Resource Control (RRC) field that could be used to indicate CSI reporting information/configuration to the UE.

Certain embodiments may provide one or more of the following technical advantage(s). Embodiments of the present disclosure may enable the network to determine if next generation NodeB (gNB) beams reported from a UE during a beam management procedure can be used for simultaneous multi-panel UL transmission or not, which will improve the performance in multi-TRP and Distributed Multiple-Input Multiple-Output (D-MIMO) systems, where typically more than one TRP/Access Point (AP) will be used for UL communication. In addition, the number of simultaneously received panels for group-based beam reporting has been increased from 2 to 4 for the embodiments disclosed herein, which could be useful in 5G advance and 6G where multi-TRP and D-MIMO deployments are expected to be more common.

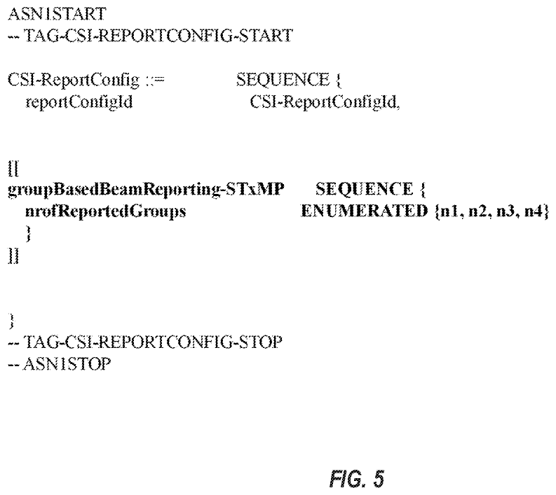

FIG. 5 illustrates one embodiment of the present disclosure, where a new field (“groupBasedBeamReporting-STxMP”) has been introduced in Report setting (CSI-ReportConfig Information Element (IE) as specified in 3GPP Technical Specification (TS) 38.331, see, e.g., V17.0.0). In one embodiment, when the parameter “nrofReportedGroups” in the field “groupBasedBeamReporting-STxMP” is configured, the UE will apply the STxMP described herein. The parameter “nrofReportedGroups” indicates the number of beam pairs (or beam groups) the UE shall include in the report.

In one embodiment, when configured with the field “groupBasedBeamReporting-STxMP”, the UE assumes that for each beam group, the UE shall only include beams that are associated with UE panels that can be used for simultaneous UL transmission (or both simultaneous UL transmission and simultaneous DL transmission (i.e., simultaneous DL reception of simultaneous DL transmissions from the network).

In one embodiment, when configured with the field “groupBasedBeamReporting-STxMP”, the UE shall include in the report for each beam pair (or each beam of a plurality of beams comprised in a beam group) whether the two (or the plurality of) reported beams are associated with UE panels that can be used for simultaneous UL transmission (or both simultaneous UL transmission and simultaneous DL transmission) or not.

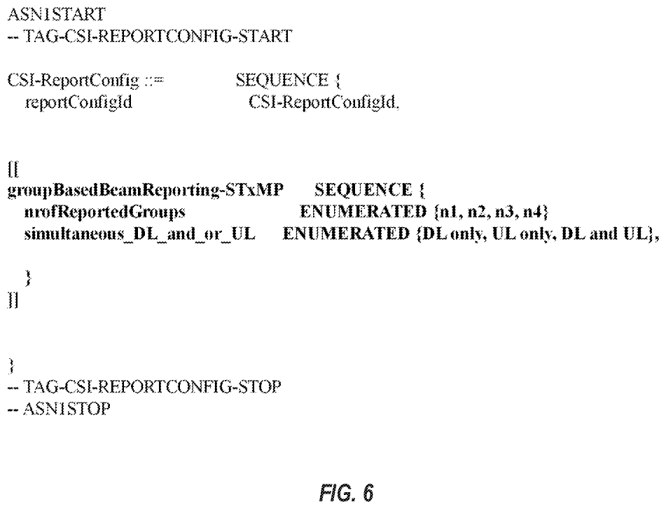

In one embodiment, illustrated in FIG. 6, the UE can be configured to consider either DL simultaneous reception (“DL only”), simultaneous UL transmission (“UL only”), or both simultaneous DL reception and simultaneous UL transmission (DL_and_UL) for the reported beams in each beam pair (or beam group). Note that only a subset of the three options might be included in the specification. For example, it might be possible to configure a UE with one out of “UL only” or “DL and UL” (but not “DL only”), or any other combination of the three options.

In one embodiment, in case the parameter “simultaneous_DL_and_or_UL” is configured as “UL only”, the UE shall make sure that the two beams in a beam pair (or the plurality of beams comprised in a beam group) are received with two (or a plurality of) UE panels that can be used for simultaneous UL transmission.

In one embodiment, in case the parameter “simultaneous_DL_and_or_UL” is configured as “DL_and_UL”, the UE shall make sure that the two beams in a beam pair (or the plurality of beams comprised in a beam group) are received with two (or a plurality of) UE panels that can be used for both simultaneous DL reception and simultaneous UL transmission.

In one embodiment, in case the parameter “simultaneous_DL_and_or_UL” is configured as “UL only”, the UE shall include in the report information for each reported beam pair (or beam group) if the two (or the plurality of) UE panels used to receive the two (or the plurality of) beams can be used for simultaneous UL transmission or not.

In one embodiment, in case the parameter “simultaneous_DL_and_or_UL” is configured as “DL_and_UL”, the UE shall include in the report information for each reported beam pair (or beam group) if the two (or plurality of) UE panels used to receive the two (or plurality of) beams can be used for simultaneous DL transmission and simultaneous UL transmission or not (requires a single bit bitfield, where, e.g., a “1” could be used to indicate that it is possible, and a “0” could indicate that it is not possible). In one embodiment, the UE includes in the report information for each reported beam pair (or beam group) if the two (or plurality of) UE panels used to receive the two (or plurality of) beams can be used for one of the following candidates (note that it might not be possible to indicate all four of these options in the report, instead only a subset of them might be possible to indicate):
Neither simultaneous DL reception or simultaneous UL transmission
Simultaneous DL reception but not simultaneous UL transmission
Simultaneous UL transmission but not simultaneous DL reception
Both simultaneous DL reception and simultaneous UL transmission

In one embodiment, depending on number of options to choose between, 1 or 2 bits will be needed in the bitfield per beam pair (or beam group).

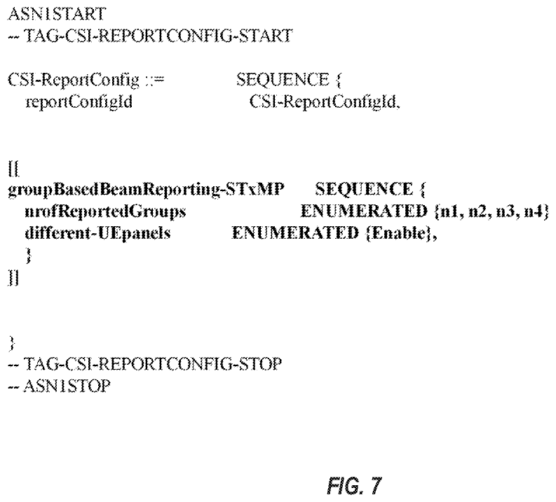

In one embodiment, illustrated in FIG. 7, the UE can be configured to consider whether the two (or the plurality of) beams in a beam pair (or beam group) are received with different or the same UE panels. Note that in case the beams are received with different UE panels, it is not guaranteed that the two UE panels can be used for simultaneous DL reception and/or UL transmission. However, for example, if the network is interested in Time Division Multiplexing (TDM) based multi-TRP reliability schemes (e.g., different beams are used for different TRPs in a time division multiplexed manner), the only thing that the network would like to know is if different UE panels are used or not for the two (or plurality of) beams in the beam group (since using different UE panels will increase the robustness against UE panel blocking).

In one embodiment, in case the parameter “different-UE panels” is configured as “Enabled”, the UE shall make sure that the two (or plurality of) beams in a beam pair (or beam group) are received with two (or a plurality of) different UE panels. In one embodiment, if the parameter is not configured, the UE shall ensure that the two (or plurality of) beams in a beam pair (or beam group) are received with two (or plurality of) UE panels that can be used for both simultaneous DL reception and/or simultaneous UL transmission. In one embodiment, if the parameter is not configured, the UE can use any UE panels for the two (or plurality of) beams in a beam pair (or beam group).

In one embodiment, in case the parameter “different-UE panels” is configured as “Enabled”, the UE shall include in the report information for each reported beam pair (or beam group) if the two (or more) UE panels used to receive the two (or more) beams are the same or different UE panels.

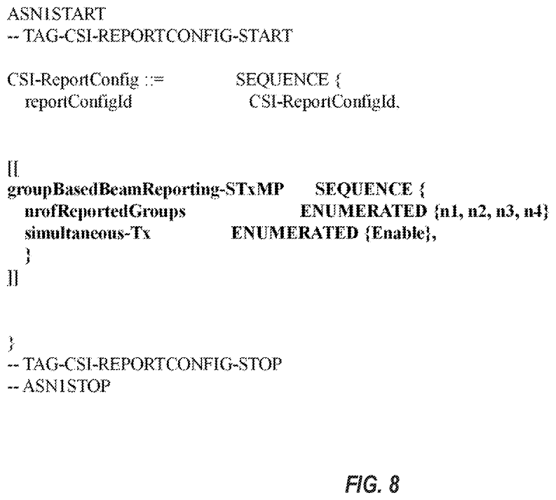

In one embodiment, illustrated in FIG. 8, the UE can be configured to consider whether the two (or more) beams in a beam pair (or beam group) can be transmitted simultaneously.

In one embodiment, in case the parameter “simultaneous-Tx” is configured” as “Enabled”, the UE shall ensure that the two (or more) beams in a beam pair (or beam group) are received with two (or more) UE panels that can be used for simultaneous UL transmission.

In one embodiment, in case the parameter “simultaneous-Tx” is configured as “Enabled”, the UE shall include in the report information for each reported beam pair (or beam group) if the two (or more) UE panels used to receive the two (or more) beams can be used for simultaneous UL transmission or not.

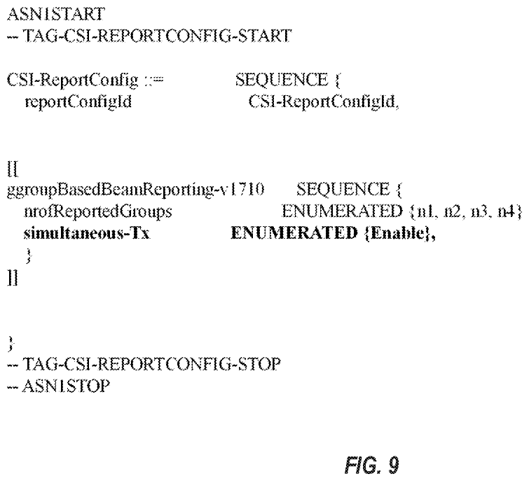

In one embodiment, schematically illustrated in FIG. 9, the parameter “simultaneous-Tx” is introduced in the field “groupBasedBeamReporting-v1710” as specified in TS 38.331 and used to indicate the Rel-17 group based beam reporting for the UE. In case the new parameter “simultaneous-Tx” is configured in “groupBasedBeamReporting-v1710”, the UE shall ensure that the two (or more) beams in a beam pair (or beam group) are received with two (or more) UE panels that can be used for both simultaneous DL reception and simultaneous UL transmission.

In another embodiment, different beam groups may be used to indicate beams that can be used for one of the three purposes given below by the gNB:
1) beams in one beam group that can be used for simultaneous DL reception with multiple UE panels; for instance, when there are N>1 (where N is an integer) beams in the beam group, simultaneous DL reception is possible with N UE panels;
2) beams in a second beam group that can be used for simultaneous UL transmission with multiple UE panels; for instance, when there are Q>1 (where Q is an integer) beams in the beam group, simultaneous UL transmission is possible with Q UE panels;
3) beams in a third beam group that can be used for both simultaneous UL transmission and simultaneous DL reception with multiple UE panels; for instance, when there are P>1 (where P is an integer) beams in the beam group, simultaneous UL transmission and simultaneous reception are possible with P UE panels;

In some cases, beam groups may be reported for any combination of 1), 2), and 3) above. The values of N, Q, and P can be same or different.

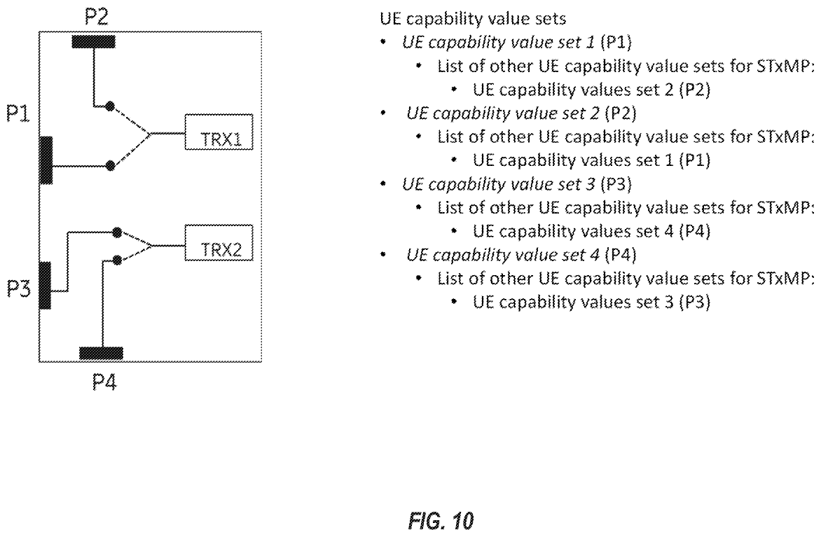

In one embodiment, the UE during UE capability signaling indicates which UE panels that can be used for simultaneous UL transmission and/or simultaneous DL reception. In one embodiment, a field is reported per UE panel (e.g., UE capability value set), and where the field indicates the other UE panels (e.g., UE capability value sets) that can be used for simultaneous UL transmission and/or DL reception with that UE panel. One schematic example is illustrated in FIG. 10.

In one embodiment, a single bitfield is used to indicate which UE panels (UE capability value sets) that can be used for simultaneous UL transmission and/or DL reception. In one embodiment, each bit of the bitfield is associated with a pair of UE panels (UE capability value sets), and a “1” indicates that the two associated UE panels can be used for UL transmission and/or DL reception and a “0” indicates that the two associated UE panels cannot be used for UL transmission and/or DL reception.

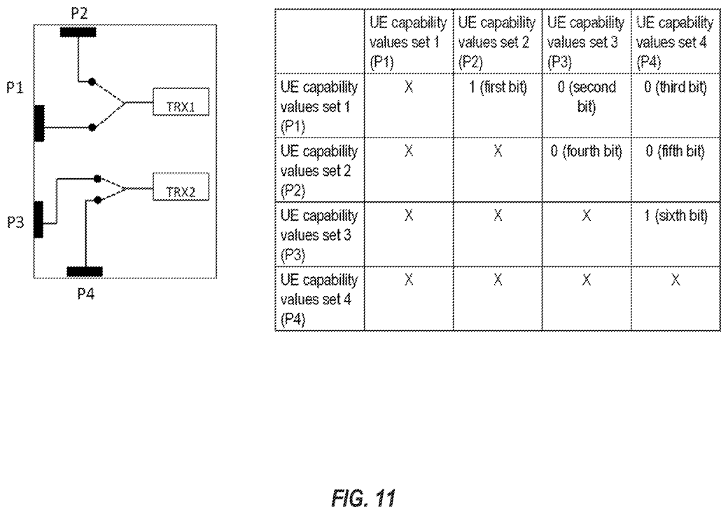

One example is illustrated in FIG. 11, where a first bit is associated with UE panel 1 (UE capability value set 1) and UE panel 2 (UE capability value set 2), second bit is associated with UE panel 1 (UE capability value set 1) and UE panel 3 (UE capability value set 3), and so on until all combination of UE panels (UE capability values sets) are done.

In one embodiment, the UE reports one bitfield for simultaneous DL reception and another separate bitfield for simultaneous UL transmission. In one embodiment, a single bitfield is used to indicate both simultaneous DL reception and simultaneous UL transmission.

In an alternative embodiment, instead of a bitfield, an integer value or an enumerated value may be reported instead of a bit field. For instance, as part of the UE capability value set, the UE may report an integer or an enumerated value representing another UE panel (e.g., another UE capability value set) with which simultaneous UL transmission and/or simultaneous DL reception may be achieved. Let us consider the following example:
UE capability value set 1 (associated with UE panel 1): an integer value 3 or an enumerated value ‘capvalset3’ is reported as part of UE capability value set 1;
UE capability value set 2 (associated with UE panel 2): an integer value of 4 or an enumerated value ‘capvalset4’ is reported as part of UE capability value set 2;
UE capability value set 3 (associated with UE panel 3);
UE capability value set 4;

In the above example, by reporting integer value 3 or enumerated value ‘capvalset3’ as part of capability reporting of UE capability value set 1, the UE signals to the gNB that UE panel 1 and UE panel 3 can be used for simultaneous UL transmission and/or simultaneous DL reception. Similarly, by reporting integer value 4 or enumerated value ‘capvalset4’ as part of capability reporting of UE capability value set 2, the UE signals to the gNB that UE panel 2 and UE panel 4 can be used for simultaneous UL transmission and/or simultaneous DL reception. Note that in some embodiments other information such as the maximum number of SRS ports supported may be included as part of the UE capability value sets. In some further embodiments, such capability value set shown in the example above may be reported separately for simultaneous UL transmission and simultaneous DL reception.

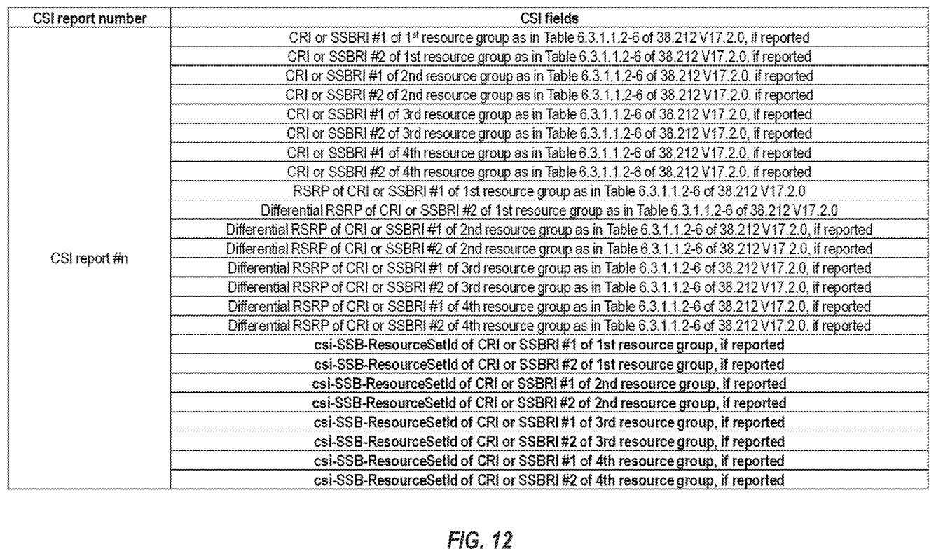

In another embodiment, more than two reference signal resource sets may be configured to the UE where the more than two reference signal resource sets correspond to more than two TRPs or more than two UE panels. Each reference signal resource set contains a plurality of reference signals (e.g., CSI-RSs or SSBs) corresponding to a plurality of beams. Hence, when reporting CRIs or SSBRIs in a beam group, the corresponding reference signal resource set ID shall also be reported by the UE for each reported CRI or SSBRI in a beam group. An example of this embodiment is shown in FIG. 12 where the CSI reporting format for up to four beam groups are shown. The reference signal set ID in the figure is given by csi-SSB-ResourceSetId. With this embodiment, when more than two reference signal sets are configured (e.g., more than two TRPs or two UE panels), then the UE can select a subset of resource sets to select the CRIs or SSBRIs in each group. For instance, the UE may select CRI/SSBRI #1 in the first beam group (or resource group) from the 1^{st} reference signal resource set, and CRI/SSBRI #2 in the first beam group (or resource group) from the 4th reference signal resource set. Alternatively, instead of reporting csi-SSB-ResourceSetId, the UE may report a TRP ID where each csi-SSB-ResourceSetId is associated with a TRP ID.

For each UE panel capable of UL transmission, it may be associated with a sounding reference signal (SRS) resource or SRS resource set. To facilitate UL transmission, an SRS resource or resource set associated to each reported beam may be included in the group based beam report. If a pair of reported beams are received by a same UE panel, the same associated SRS resource or resource set would be included for both the beams. If a pair of reported beams are received by two different UE panels, two different associated SRS resources or resource sets would be included for the two beams. In this way, the network would know whether a pair of reported beams are received by a same UE panel or different UE panels. In addition, when UL simultaneous transmission capability is indicated for a pair of reported beams, the network would know the associated two SRS resources or resource sets for UL channel measurement and data transmission. For example, the network may trigger a simultaneous transmission of the two SRS resources and resource sets by the UE and measures UL channels at two TRPs where the corresponding DL beams were transmitted. The network can then figure out UL channel quality at each of the TRPs by taking into account interference from the unintended SRS resource or resource set. The network can then schedule UL simultaneous PUSCH transmission from two UE panels associated with the SRS resources or resource sets by indicating the SRS resources or resource sets and other scheduling parameters such as modulation and coding schemes, antenna precoding matrix, and etc. associated with each UE panel.

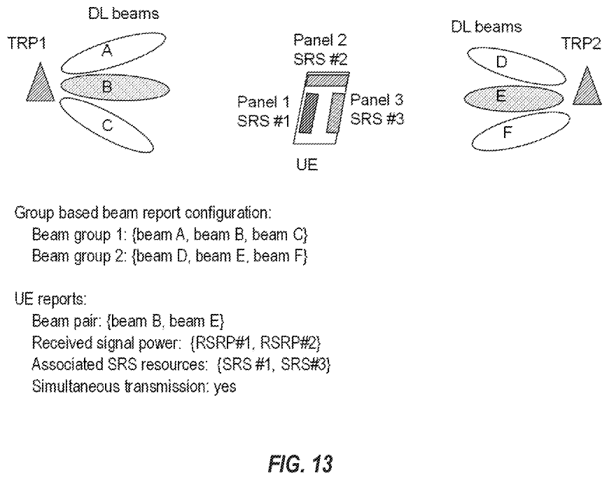

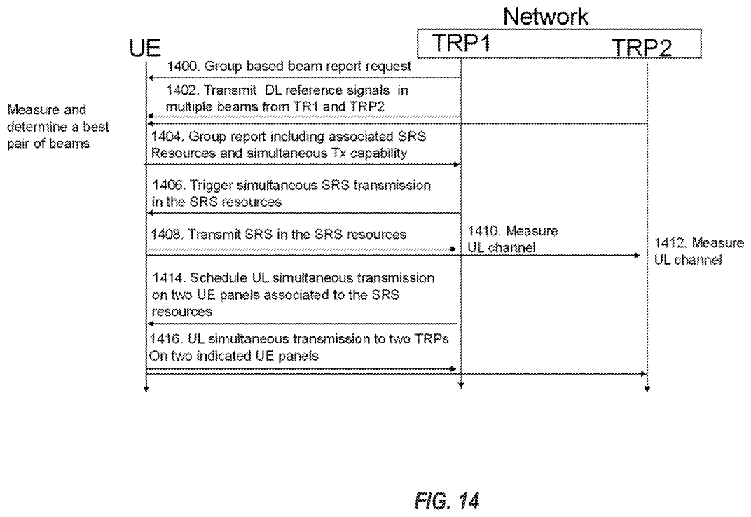

An example is shown in FIG. 13, where there are two TRPs and a UE. The UE is equipped with three UE panels. To determine which two beams from the two TRPs can be received simultaneously by the UE, a group based beam report can be requested by the network to the UE, in which three DL beams from each of the two TRPs are configured. The UE would measure all the configured beams and determine a best pair of beams that can be received on its three UE panels. In this case, beam B on panel 1 and beam E on panel 3 would be reported together with their received powers. In addition, the UE would also report the associated SRS resource or resource set for each of the two beams and whether simultaneous UL transmission is supported on the associated UE panels. An example of signaling between the UE and the network is shown in FIG. 14.

In regard to FIG. 14, please note that this flowchart is for the embodiments related to reporting associated SRS resource (i.e., the flowchart does not apply to other embodiments covered in the present disclosure). As illustrated in FIG. 14, a first TRP (TRP1) sends a group based beam report request to the UE (step 1400). Using the example of FIG. 13, the group based beam report can be requested by the network to the UE, in which three DL beams from each of the two TRPs are configured. TRP1 and a second TRP (TRP2) transmit DL reference signals in multiple beams (step 1402). As discussed above, the UE measures all the configured beams and determines a best pair of beams that can be received on its UE panels. The UE sends a group based beam report to TRP1, where this group based beam report includes associated SRS resources and simultaneous Tx capability (step 1404). Using the example of FIG. 13, beam B on panel 1 and beam E on panel 3 would be reported together with their received powers. In addition, the UE would also report the associated SRS resource or resource set for each of the two beams and whether simultaneous UL transmission is supported on the associated UE panels. TRP1 may then trigger simultaneous SRS transmission in the SRS resources (step 1406). In response, the UE transmits SRS in the SRS resources (step 1408). TRP1 measures the respective UL channel between the UE and TRP1 (step 1410), and TRP measures the respective UL channel between the UE and TRP2 (step 1412). TRP1 may then schedule the UE for simultaneous UL transmission on two UE panels associated to the SRS resources (step 1414). The UE may then perform simultaneous UL transmission to the two TRPs on the two indicated UE panels (step 1416).

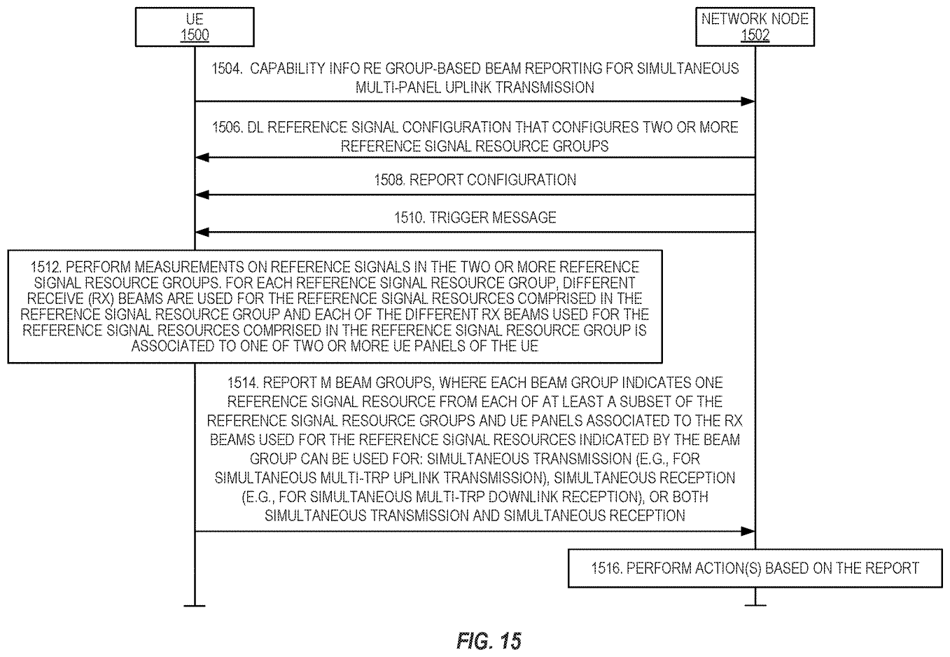

FIG. 15 illustrates the operation of a UE 1500 and a network node 1502 (e.g., a base station such as, e.g., a gNB) in accordance with at least some of the embodiments described above. Note that not all details provided above are repeated here in the description of FIG. 15. However, it is to be understood that the details above are also applicable here to the process of FIG. 15. The steps of the procedure of FIG. 15 are as follows.

Step 1504 (Optional): The UE 1500 transmits, to the network node 1502, capability information that comprises an indication that the UE supports group-based beam reporting for simultaneous multi-panel uplink transmission. In one embodiment, the capability information further comprises: information that indicates a number of UE panels at the UE, information that indicates which UE panels can be used for simultaneous uplink transmission, information that indicates which UE panels can be used for simultaneous downlink reception, information that indicates which UE panels can be used for simultaneous uplink transmission and simultaneous downlink reception, or a combination of any two or more thereof. In one embodiment, the capability information further comprises, for each UE panel of the two or more UE panels of the UE: information that indicates which other UE panel(s) can be used together with the UE panel for simultaneous uplink transmission, information that indicates which other UE panel(s) can be used together with the UE panel for simultaneous downlink reception, information that indicates which other UE panel(s) can be used together with the UE panel for simultaneous uplink transmission and simultaneous downlink reception, or a combination of any two or more thereof. In one embodiment, the capability information comprises a bitfield that indicates which UE panels can be used for simultaneous uplink transmission and/or simultaneous downlink reception, wherein each bit of the bitfield is associated with a set (e.g., pair) of UE panels.

Step 1506: The UE 1500 receives, from the network node 1502, a downlink reference signal configuration (e.g., a DL CSI-RS configuration) that configures two or more reference signal resource groups, wherein each reference signal resource group of the two or more reference signal resource groups comprises two or more reference signal resources. For example, the two or more reference signal resource groups may include a first reference signal resource group and a second reference signal resource group.

Step 1508 (Optional): The UE 1500 receives, from the network node 1502, a report configuration associated to the downlink reference signal configuration. In one embodiment, the report configuration comprises a report setting field. In one embodiment, the report configuration (e.g., the report setting field) indicates that the UE is to perform group-based beam reporting for STxMP. In one embodiment, the report configuration (e.g., the report setting field) comprises an indication that the UE is to use a first spatial filter when receiving a first reference signal in a reported pair of reference signals (i.e., when receiving a first reference signal in a first reference signal resource in a group (e.g., pair) of reference signal resources), and a second spatial filter when receiving a second reference signal in the reported pair of reference signals (i.e., when receiving a second reference signal in a second reference signal resource in the group (e.g., pair) of reference signal resources), and where the first and second spatial filters are associated with a same or different UE panels. In another embodiment, the report configuration (e.g., the report setting field) comprises an indication that the UE is to use a first spatial filter when receiving a first reference signal in a reported pair of reference signals (i.e., when receiving a first reference signal in a first reference signal resource in a group (e.g., pair) of reference signal resources), and a second spatial filter when receiving a second reference signal in the reported pair of reference signals (i.e., when receiving a second reference signal in a second reference signal resource in the group (e.g., pair) of reference signal resources), and where the first and second spatial filters are not associated with a same UE panel. In another embodiment, the report configuration (e.g., the report setting field) comprises an indication that the UE is to use a first spatial filter (associated with a first UE panel) when receiving a first reference signal in a reported pair of reference signals (i.e., when receiving a first reference signal in a first reference signal resource in a group (e.g., pair) of reference signal resources), and a second spatial filter (associated with a second UE panel) when receiving a second reference signal in the reported pair of reference signals (i.e., when receiving a second reference signal in a second reference signal resource in the group (e.g., pair) of reference signal resources), and where the first and second spatial filters are not associated with the same UE panel and where the two different UE panels (first UE panel and second UE panel) can be used for simultaneous transmission. In another embodiment, the report configuration (e.g., the report setting field) comprises information that configures the UE to include, in the report, an indication of the UE panel (e.g., UE panel ID, virtual UE panel ID, UE capability values set, SRS resource set ID, SRS resource ID) associated with each of reported reference signal resource in each of the M beam groups. In another embodiment, the report configuration (e.g., the report setting field) comprises an indication that the UE is to report if a first UE panel associated with a first reported reference signal (i.e., associated with a first reference signal resource in a reference signal resource group) in a reported beam group and a second UE panel associated with a second reported reference signal (i.e., associated with a second reference signal resource in the reference signal resource group) in the same reported beam group can be used for simultaneous UL transmission or not. In another embodiment, the report configuration (e.g., the report setting field) comprises an indication that the UE is to report if a first UE panel associated with a first reported reference signal resource in a reported beam group and a second UE panel associated with a second reported reference signal resource in the same reported beam pair can be used for simultaneous UL transmission, simultaneous DL reception, both simultaneous UL transmission and simultaneous DL reception, or neither simultaneous UL transmission nor simultaneous DL transmission. In another embodiment, the report configuration (e.g., the report setting field) comprises an indication of which of the three candidate options that the UE should assume for the report, i.e. the UE can be configured to follow one of: (a) UE panels associated to the Rx beams used for the reference signal resources indicated by the beam group can be used for simultaneous UL transmission, (b) UE panels associated to the Rx beams used for the reference signal resources indicated by the beam group can be used for simultaneous DL reception, or (c) UE panels associated to the Rx beams used for the reference signal resources indicated by the beam group can be used for both simultaneous UL transmission and simultaneous DL reception.

Step 1510 (Optional): In one embodiment, the UE 1500 receives a trigger message that initiates the performing of the measurements in accordance with the report configuration.

Step 1512: The UE 1500 performs measurements on reference signals within the two or more reference signal resource groups. For each reference signal resource group of the two or more reference signal resource groups, different receive (Rx) beams are used for the two or more reference signal resources comprised in the reference signal resource group and each of the different Rx beams used for the two or more reference signal resources comprised in the reference signal resource group is associated to one of two or more UE panels of the UE.

Step 1514: Based on the measurements, the UE 1500 reports, to the network node 1502, M beam groups. In other words, the UE 1500 sends, to the network node 1502, information for the M beam groups, where this information is, in one embodiment, included in a report (e.g., a group-based beam report). For each beam group of the M beam groups, the beam group (i.e., the information reported for the beam group) indicates one reference signal resource from each of at least a subset of the two or more reference signal resource groups and UE panels associated to the Rx beams used for the reference signal resources indicated by the beam group can be used for: simultaneous transmission (e.g., for simultaneous multi-TRP uplink transmission), simultaneous reception (e.g., for simultaneous multi-TRP downlink reception), or both simultaneous transmission and simultaneous reception (e.g., in accordance with any of the embodiments described herein).

In one embodiment, reporting the M beam groups comprises sending a respective report to the network node. In one embodiment, the report further comprises a performance metric for each reported reference signal resource for each of the M beam groups. In one embodiment, the performance metric indicates uplink performance. In one embodiment, the performance metric indicates downlink reference signal received power+uplink power factor. In one embodiment, the uplink power factor is associated with the UE panel that was used to receive the associated reference signal. In one embodiment, the uplink power factor considers either or both of: (i) Power management Maximum Power Reduction (P-MPR) associated with the UE panel and (ii) maximum available output power associated with the UE panel.

In one embodiment, the report further comprises information that indicates the UE panel associated with each reported reference signal resource for each of the M beam groups.

In one embodiment, the report further comprises, for each reported set of reference signal resources for each of the M beam groups, information that indicates that different Rx beams were used for reception of associated reference signals for each of the set of reference signal resources.

In one embodiment, the report further comprises, for each reported set of reference signal resources for each of the M beam groups, information that indicates that different Rx beams were used for reception of associated reference signals for each of the set of reference signal resources and the associated UE panels can be used for simultaneous uplink transmission.

In one embodiment, the report further comprises, for each reported set of reference signal resources for each of the M beam groups, information that indicates that different Rx beams were used for reception of associated reference signals for each of the set of reference signal resources and the associated UE panels can be used for simultaneous downlink reception.

Step 1516: The network node 1502 performs one or more actions based on the reported M beam groups. The one or more actions may include, e.g., scheduling simultaneous downlink reception to the UE 1500 and/or simultaneous uplink transmission from the UE 1500, in accordance with the received report.

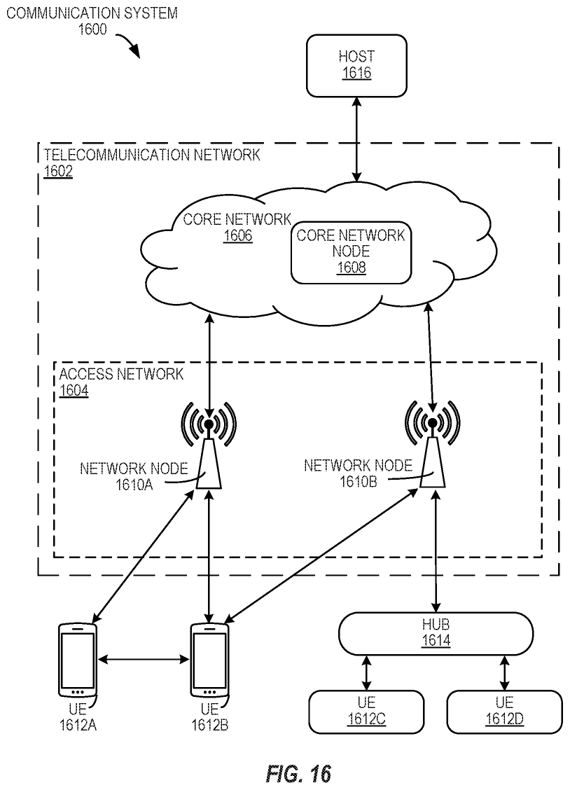

FIG. 16 shows an example of a communication system 1600 in accordance with some embodiments.

In the example, the communication system 1600 includes a telecommunication network 1602 that includes an access network 1604, such as a Radio Access Network (RAN), and a core network 1606, which includes one or more core network nodes 1608. The access network 1604 includes one or more access network nodes, such as network nodes 1610A and 1610B (one or more of which may be generally referred to as network nodes 1610), or any other similar Third Generation Partnership Project (3GPP) access node or non-3GPP Access Point (AP). The network nodes 1610 facilitate direct or indirect connection of User Equipment (UE), such as by connecting UEs 1612A, 1612B, 1612C, and 1612D (one or more of which may be generally referred to as UEs 1612) to the core network 1606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 1600 may include any number of wired or wireless networks, network nodes, UEs, and/or any other components or systems that may facilitate or participate in the communication of data and/or signals whether via wired or wireless connections. The communication system 1600 may include and/or interface with any type of communication, telecommunication, data, cellular, radio network, and/or other similar type of system.

The UEs 1612 may be any of a wide variety of communication devices, including wireless devices arranged, configured, and/or operable to communicate wirelessly with the network nodes 1610 and other communication devices. Similarly, the network nodes 1610 are arranged, capable, configured, and/or operable to communicate directly or indirectly with the UEs 1612 and/or with other network nodes or equipment in the telecommunication network 1602 to enable and/or provide network access, such as wireless network access, and/or to perform other functions, such as administration in the telecommunication network 1602.

In the depicted example, the core network 1606 connects the network nodes 1610 to one or more hosts, such as host 1616. These connections may be direct or indirect via one or more intermediary networks or devices. In other examples, network nodes may be directly coupled to hosts. The core network 1606 includes one more core network nodes (e.g., core network node 1608) that are structured with hardware and software components. Features of these components may be substantially similar to those described with respect to the UEs, network nodes, and/or hosts, such that the descriptions thereof are generally applicable to the corresponding components of the core network node 1608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 1616 may be under the ownership or control of a service provider other than an operator or provider of the access network 1604 and/or the telecommunication network 1602, and may be operated by the service provider or on behalf of the service provider. The host 1616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 1600 of FIG. 16 enables connectivity between the UEs, network nodes, and hosts. In that sense, the communication system 1600 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 1602 is a cellular network that implements 3GPP standardized features. Accordingly, the telecommunication network 1602 may support network slicing to provide different logical networks to different devices that are connected to the telecommunication network 1602. For example, the telecommunication network 1602 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 1612 are configured to transmit and/or receive information without direct human interaction. For instance, a UE may be designed to transmit information to the access network 1604 on a predetermined schedule, when triggered by an internal or external event, or in response to requests from the access network 1604. Additionally, a UE may be configured for operating in single- or multi-Radio Access Technology (RAT) or multi-standard mode. For example, a UE may operate with any one or combination of WiFi, New Radio (NR), and LTE, i.e. be configured for Multi-Radio Dual Connectivity (MR-DC), such as Evolved UMTS Terrestrial RAN (E-UTRAN) NR-Dual Connectivity (EN-DC).

In the example, a hub 1614 communicates with the access network 1604 to facilitate indirect communication between one or more UEs (e.g., UE 1612C and/or 1612D) and network nodes (e.g., network node 1610B). In some examples, the hub 1614 may be a controller, router, content source and analytics, or any of the other communication devices described herein regarding UEs. For example, the hub 1614 may be a broadband router enabling access to the core network 1606 for the UEs. As another example, the hub 1614 may be a controller that sends commands or instructions to one or more actuators in the UEs. Commands or instructions may be received from the UEs, network nodes 1610, or by executable code, script, process, or other instructions in the hub 1614. As another example, the hub 1614 may be a data collector that acts as temporary storage for UE data and, in some embodiments, may perform analysis or other processing of the data. As another example, the hub 1614 may be a content source. For example, for a UE that is a Virtual Reality (VR) headset, display, loudspeaker or other media delivery device, the hub 1614 may retrieve VR assets, video, audio, or other media or data related to sensory information via a network node, which the hub 1614 then provides to the UE either directly, after performing local processing, and/or after adding additional local content. In still another example, the hub 1614 acts as a proxy server or orchestrator for the UEs, in particular in if one or more of the UEs are low energy IoT devices.

The hub 1614 may have a constant/persistent or intermittent connection to the network node 1610B. The hub 1614 may also allow for a different communication scheme and/or schedule between the hub 1614 and UEs (e.g., UE 1612C and/or 1612D), and between the hub 1614 and the core network 1606. In other examples, the hub 1614 is connected to the core network 1606 and/or one or more UEs via a wired connection. Moreover, the hub 1614 may be configured to connect to a Machine-to-Machine (M2M) service provider over the access network 1604 and/or to another UE over a direct connection. In some scenarios, UEs may establish a wireless connection with the network nodes 1610 while still connected via the hub 1614 via a wired or wireless connection. In some embodiments, the hub 1614 may be a dedicated hub—that is, a hub whose primary function is to route communications to/from the UEs from/to the network node 1610B. In other embodiments, the hub 1614 may be a non-dedicated hub—that is, a device which is capable of operating to route communications between the UEs and the network node 1610B, but which is additionally capable of operating as a communication start and/or end point for certain data channels.

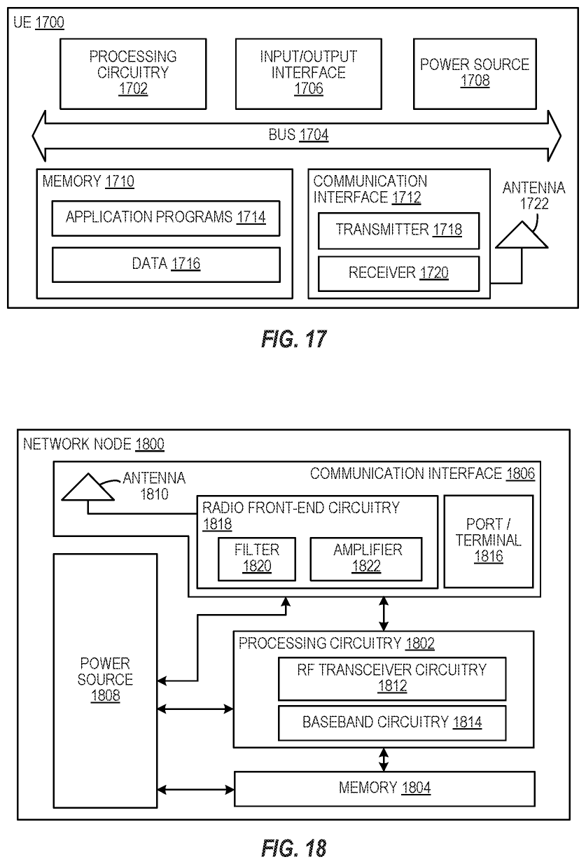

FIG. 17 shows a UE 1700 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VOIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 1700 includes processing circuitry 1702 that is operatively coupled via a bus 1704 to an input/output interface 1706, a power source 1708, memory 1710, a communication interface 1712, and/or any other component, or any combination thereof. Certain UEs may utilize all or a subset of the components shown in FIG. 17. The level of integration between the components may vary from one UE to another UE. Further, certain UEs may contain multiple instances of a component, such as multiple processors, memories, transceivers, transmitters, receivers, etc.

The processing circuitry 1702 is configured to process instructions and data and may be configured to implement any sequential state machine operative to execute instructions stored as machine-readable computer programs in the memory 1710. The processing circuitry 1702 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 1702 may include multiple Central Processing Units (CPUs).

In the example, the input/output interface 1706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 1700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 1708 is structured as a battery or battery pack. Other types of power sources, such as an external power source (e.g., an electricity outlet), photovoltaic device, or power cell, may be used. The power source 1708 may further include power circuitry for delivering power from the power source 1708 itself, and/or an external power source, to the various parts of the UE 1700 via input circuitry or an interface such as an electrical power cable. Delivering power may be, for example, for charging the power source 1708. Power circuitry may perform any formatting, converting, or other modification to the power from the power source 1708 to make the power suitable for the respective components of the UE 1700 to which power is supplied.

The memory 1710 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 1710 includes one or more application programs 1714, such as an operating system, web browser application, a widget, gadget engine, or other application, and corresponding data 1716. The memory 1710 may store, for use by the UE 1700, any of a variety of various operating systems or combinations of operating systems.

The memory 1710 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 1710 may allow the UE 1700 to access instructions, application programs, and the like stored on transitory or non-transitory memory media, to off-load data, or to upload data. An article of manufacture, such as one utilizing a communication system, may be tangibly embodied as or in the memory 1710, which may be or comprise a device-readable storage medium.

The processing circuitry 1702 may be configured to communicate with an access network or other network using the communication interface 1712. The communication interface 1712 may comprise one or more communication subsystems and may include or be communicatively coupled to an antenna 1722. The communication interface 1712 may include one or more transceivers used to communicate, such as by communicating with one or more remote transceivers of another device capable of wireless communication (e.g., another UE or a network node in an access network). Each transceiver may include a transmitter 1718 and/or a receiver 1720 appropriate to provide network communications (e.g., optical, electrical, frequency allocations, and so forth). Moreover, the transmitter 1718 and receiver 1720 may be coupled to one or more antennas (e.g., the antenna 1722) and may share circuit components, software, or firmware, or alternatively be implemented separately.

In the illustrated embodiment, communication functions of the communication interface 1712 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 1712, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 1700 shown in FIG. 17.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 18 shows a network node 1800 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 1800 includes processing circuitry 1802, memory 1804, a communication interface 1806, and a power source 1808. The network node 1800 may be composed of multiple physically separate components (e.g., a Node B component and an RNC component, or a BTS component and a BSC component, etc.), which may each have their own respective components. In certain scenarios in which the network node 1800 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 1800 may be configured to support multiple RATs. In such embodiments, some components may be duplicated (e.g., separate memory 1804 for different RATs) and some components may be reused (e.g., an antenna 1810 may be shared by different RATs). The network node 1800 may also include multiple sets of the various illustrated components for different wireless technologies integrated into network node 1800, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 1800.

The processing circuitry 1802 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 1800 components, such as the memory 1804, to provide network node 1800 functionality.

In some embodiments, the processing circuitry 1802 includes a System on a Chip (SOC). In some embodiments, the processing circuitry 1802 includes one or more of Radio Frequency (RF) transceiver circuitry 1812 and baseband processing circuitry 1814. In some embodiments, the RF transceiver circuitry 1812 and the baseband processing circuitry 1814 may be on separate chips (or sets of chips), boards, or units, such as radio units and digital units. In alternative embodiments, part or all of the RF transceiver circuitry 1812 and the baseband processing circuitry 1814 may be on the same chip or set of chips, boards, or units.

The memory 1804 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 1802. The memory 1804 may store any suitable instructions, data, or information, including a computer program, software, an application including one or more of logic, rules, code, tables, and/or other instructions capable of being executed by the processing circuitry 1802 and utilized by the network node 1800. The memory 1804 may be used to store any calculations made by the processing circuitry 1802 and/or any data received via the communication interface 1806. In some embodiments, the processing circuitry 1802 and the memory 1804 are integrated.

The communication interface 1806 is used in wired or wireless communication of signaling and/or data between a network node, access network, and/or UE. As illustrated, the communication interface 1806 comprises port(s)/terminal(s) 1816 to send and receive data, for example to and from a network over a wired connection. The communication interface 1806 also includes radio front-end circuitry 1818 that may be coupled to, or in certain embodiments a part of, the antenna 1810. The radio front-end circuitry 1818 comprises filters 1820 and amplifiers 1822. The radio front-end circuitry 1818 may be connected to the antenna 1810 and the processing circuitry 1802. The radio front-end circuitry 1818 may be configured to condition signals communicated between the antenna 1810 and the processing circuitry 1802. The radio front-end circuitry 1818 may receive digital data that is to be sent out to other network nodes or UEs via a wireless connection. The radio front-end circuitry 1818 may convert the digital data into a radio signal having the appropriate channel and bandwidth parameters using a combination of the filters 1820 and/or the amplifiers 1822. The radio signal may then be transmitted via the antenna 1810. Similarly, when receiving data, the antenna 1810 may collect radio signals which are then converted into digital data by the radio front-end circuitry 1818. The digital data may be passed to the processing circuitry 1802. In other embodiments, the communication interface 1806 may comprise different components and/or different combinations of components.

In certain alternative embodiments, the network node 1800 does not include separate radio front-end circuitry 1818; instead, the processing circuitry 1802 includes radio front-end circuitry and is connected to the antenna 1810. Similarly, in some embodiments, all or some of the RF transceiver circuitry 1812 is part of the communication interface 1806. In still other embodiments, the communication interface 1806 includes the one or more ports or terminals 1816, the radio front-end circuitry 1818, and the RF transceiver circuitry 1812 as part of a radio unit (not shown), and the communication interface 1806 communicates with the baseband processing circuitry 1814, which is part of a digital unit (not shown).

The antenna 1810 may include one or more antennas, or antenna arrays, configured to send and/or receive wireless signals. The antenna 1810 may be coupled to the radio front-end circuitry 1818 and may be any type of antenna capable of transmitting and receiving data and/or signals wirelessly. In certain embodiments, the antenna 1810 is separate from the network node 1800 and connectable to the network node 1800 through an interface or port.

The antenna 1810, the communication interface 1806, and/or the processing circuitry 1802 may be configured to perform any receiving operations and/or certain obtaining operations described herein as being performed by the network node 1800. Any information, data, and/or signals may be received from a UE, another network node, and/or any other network equipment. Similarly, the antenna 1810, the communication interface 1806, and/or the processing circuitry 1802 may be configured to perform any transmitting operations described herein as being performed by the network node 1800. Any information, data, and/or signals may be transmitted to a UE, another network node, and/or any other network equipment.

The power source 1808 provides power to the various components of the network node 1800 in a form suitable for the respective components (e.g., at a voltage and current level needed for each respective component). The power source 1808 may further comprise, or be coupled to, power management circuitry to supply the components of the network node 1800 with power for performing the functionality described herein. For example, the network node 1800 may be connectable to an external power source (e.g., the power grid or an electricity outlet) via input circuitry or an interface such as an electrical cable, whereby the external power source supplies power to power circuitry of the power source 1808. As a further example, the power source 1808 may comprise a source of power in the form of a battery or battery pack which is connected to, or integrated in, power circuitry. The battery may provide backup power should the external power source fail.

Embodiments of the network node 1800 may include additional components beyond those shown in FIG. 18 for providing certain aspects of the network node's functionality, including any of the functionality described herein and/or any functionality necessary to support the subject matter described herein. For example, the network node 1800 may include user interface equipment to allow input of information into the network node 1800 and to allow output of information from the network node 1800. This may allow a user to perform diagnostic, maintenance, repair, and other administrative functions for the network node 1800.

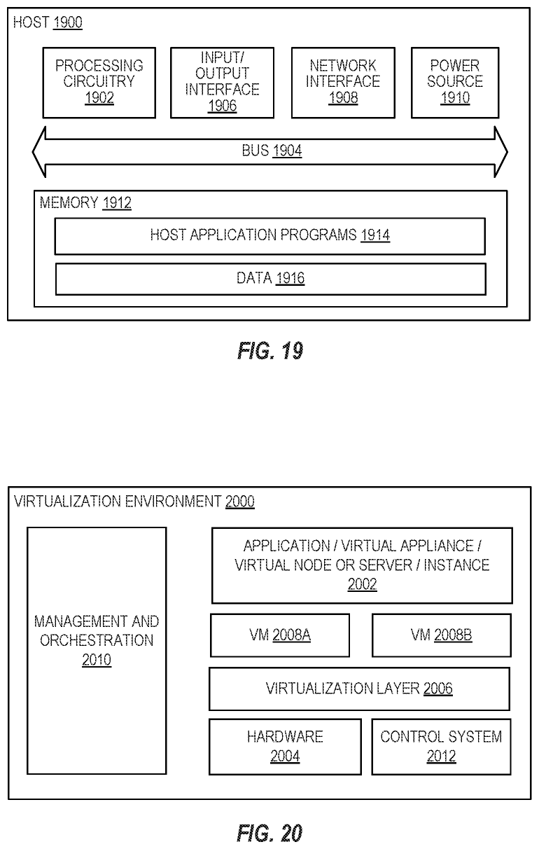

FIG. 19 is a block diagram of a host 1900, which may be an embodiment of the host 1616 of FIG. 16, in accordance with various aspects described herein. As used herein, the host 1900 may be or comprise various combinations of hardware and/or software including a standalone server, a blade server, a cloud-implemented server, a distributed server, a virtual machine, container, or processing resources in a server farm. The host 1900 may provide one or more services to one or more UEs.

The host 1900 includes processing circuitry 1902 that is operatively coupled via a bus 1904 to an input/output interface 1906, a network interface 1908, a power source 1910, and memory 1912. Other components may be included in other embodiments. Features of these components may be substantially similar to those described with respect to the devices of previous figures, such as FIGS. 17 and 18, such that the descriptions thereof are generally applicable to the corresponding components of the host 1900.

The memory 1912 may include one or more computer programs including one or more host application programs 1914 and data 1916, which may include user data, e.g. data generated by a UE for the host 1900 or data generated by the host 1900 for a UE. Embodiments of the host 1900 may utilize only a subset or all of the components shown. The host application programs 1914 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 1914 may also provide for user authentication and licensing checks and may periodically report health, routes, and content availability to a central node, such as a device in or on the edge of a core network. Accordingly, the host 1900 may select and/or indicate a different host for Over-The-Top (OTT) services for a UE. The host application programs 1914 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 20 is a block diagram illustrating a virtualization environment 2000 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 2000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 2002 (which may alternatively be called software instances, virtual appliances, network functions, virtual nodes, virtual network functions, etc.) are run in the virtualization environment 1900 to implement some of the features, functions, and/or benefits of some of the embodiments disclosed herein.

Hardware 2004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 2006 (also referred to as hypervisors or VM Monitors (VMMs)), provide VMs 2008A and 2008B (one or more of which may be generally referred to as VMs 2008), and/or perform any of the functions, features, and/or benefits described in relation with some embodiments described herein. The virtualization layer 2006 may present a virtual operating platform that appears like networking hardware to the VMs 2008.

The VMs 2008 comprise virtual processing, virtual memory, virtual networking, or interface and virtual storage, and may be run by a corresponding virtualization layer 2006. Different embodiments of the instance of a virtual appliance 2002 may be implemented on one or more of the VMs 2008, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 2008 may be a software implementation of a physical machine that runs programs as if they were executing on a physical, non-virtualized machine. Each of the VMs 2008, and that part of the hardware 2004 that executes that VM, be it hardware dedicated to that VM and/or hardware shared by that VM with others of the VMs 2008, forms separate virtual network elements. Still in the context of NFV, a virtual network function is responsible for handling specific network functions that run in one or more VMs 2008 on top of the hardware 2004 and corresponds to the application 2002.

The hardware 2004 may be implemented in a standalone network node with generic or specific components. The hardware 2004 may implement some functions via virtualization. Alternatively, the hardware 2004 may be part of a larger cluster of hardware (e.g., such as in a data center or CPE) where many hardware nodes work together and are managed via management and orchestration 2010, which, among others, oversees lifecycle management of the applications 2002. In some embodiments, the hardware 2004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 2012 which may alternatively be used for communication between hardware nodes and radio units.

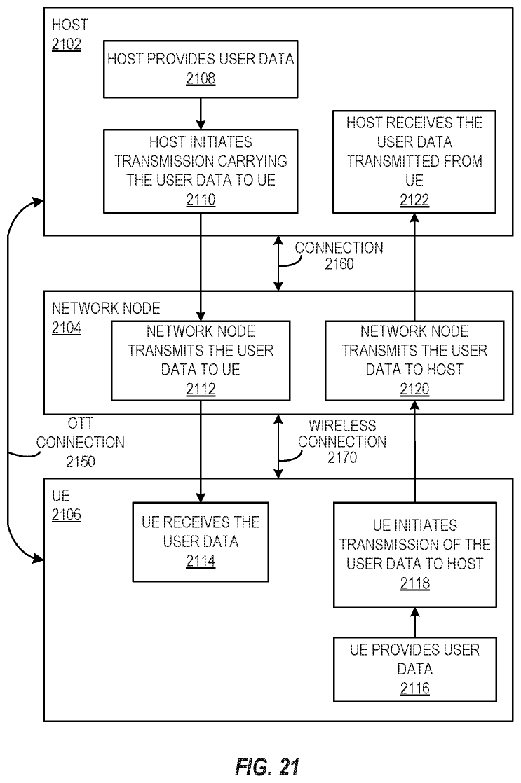

FIG. 21 shows a communication diagram of a host 2102 communicating via a network node 2104 with a UE 2106 over a partially wireless connection in accordance with some embodiments. Example implementations, in accordance with various embodiments, of the UE (such as the UE 1612A of FIG. 16 and/or the UE 1700 of FIG. 17), the network node (such as the network node 1610A of FIG. 16 and/or the network node 1800 of FIG. 18), and the host (such as the host 1616 of FIG. 16 and/or the host 1900 of FIG. 19) discussed in the preceding paragraphs will now be described with reference to FIG. 21.

Like the host 1900, embodiments of the host 2102 include hardware, such as a communication interface, processing circuitry, and memory. The host 2102 also includes software, which is stored in or is accessible by the host 2102 and executable by the processing circuitry. The software includes a host application that may be operable to provide a service to a remote user, such as the UE 2106 connecting via an OTT connection 2150 extending between the UE 2106 and the host 2102. In providing the service to the remote user, a host application may provide user data which is transmitted using the OTT connection 2150.

The network node 2104 includes hardware enabling it to communicate with the host 2102 and the UE 2106 via a connection 2160. The connection 2160 may be direct or pass through a core network (like the core network 1606 of FIG. 16) and/or one or more other intermediate networks, such as one or more public, private, or hosted networks. For example, an intermediate network may be a backbone network or the Internet.

The UE 2106 includes hardware and software, which is stored in or accessible by the UE 2106 and executable by the UE's processing circuitry. The software includes a client application, such as a web browser or operator-specific “app” that may be operable to provide a service to a human or non-human user via the UE 2106 with the support of the host 2102. In the host 2102, an executing host application may communicate with the executing client application via the OTT connection 2150 terminating at the UE 2106 and the host 2102. In providing the service to the user, the UE's client application may receive request data from the host's host application and provide user data in response to the request data. The OTT connection 2150 may transfer both the request data and the user data. The UE's client application may interact with the user to generate the user data that it provides to the host application through the OTT connection 2150.

The OTT connection 2150 may extend via the connection 2160 between the host 2102 and the network node 2104 and via a wireless connection 2170 between the network node 2104 and the UE 2106 to provide the connection between the host 2102 and the UE 2106. The connection 2160 and the wireless connection 2170, over which the OTT connection 2150 may be provided, have been drawn abstractly to illustrate the communication between the host 2102 and the UE 2106 via the network node 2104, without explicit reference to any intermediary devices and the precise routing of messages via these devices.

As an example of transmitting data via the OTT connection 2150, in step 2108, the host 2102 provides user data, which may be performed by executing a host application. In some embodiments, the user data is associated with a particular human user interacting with the UE 2106. In other embodiments, the user data is associated with a UE 2106 that shares data with the host 2102 without explicit human interaction. In step 2110, the host 2102 initiates a transmission carrying the user data towards the UE 2106. The host 2102 may initiate the transmission responsive to a request transmitted by the UE 2106. The request may be caused by human interaction with the UE 2106 or by operation of the client application executing on the UE 2106. The transmission may pass via the network node 2104 in accordance with the teachings of the embodiments described throughout this disclosure. Accordingly, in step 2112, the network node 2104 transmits to the UE 2106 the user data that was carried in the transmission that the host 2102 initiated, in accordance with the teachings of the embodiments described throughout this disclosure. In step 2114, the UE 2106 receives the user data carried in the transmission, which may be performed by a client application executed on the UE 2106 associated with the host application executed by the host 2102.

In some examples, the UE 2106 executes a client application which provides user data to the host 2102. The user data may be provided in reaction or response to the data received from the host 2102. Accordingly, in step 2116, the UE 2106 may provide user data, which may be performed by executing the client application. In providing the user data, the client application may further consider user input received from the user via an input/output interface of the UE 2106. Regardless of the specific manner in which the user data was provided, the UE 2106 initiates, in step 2118, transmission of the user data towards the host 2102 via the network node 2104. In step 2120, in accordance with the teachings of the embodiments described throughout this disclosure, the network node 2104 receives user data from the UE 2106 and initiates transmission of the received user data towards the host 2102. In step 2122, the host 2102 receives the user data carried in the transmission initiated by the UE 2106.

One or more of the various embodiments improve the performance of OTT services provided to the UE 2106 using the OTT connection 2150, in which the wireless connection 2170 forms the last segment.

In an example scenario, factory status information may be collected and analyzed by the host 2102. As another example, the host 2102 may process audio and video data which may have been retrieved from a UE for use in creating maps. As another example, the host 2102 may collect and analyze real-time data to assist in controlling vehicle congestion (e.g., controlling traffic lights). As another example, the host 2102 may store surveillance video uploaded by a UE. As another example, the host 2102 may store or control access to media content such as video, audio, VR, or AR which it can broadcast, multicast, or unicast to UEs. As other examples, the host 2102 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 2150 between the host 2102 and the UE 2106 in response to variations in the measurement results. The measurement procedure and/or the network functionality for reconfiguring the OTT connection 2150 may be implemented in software and hardware of the host 2102 and/or the UE 2106. In some embodiments, sensors (not shown) may be deployed in or in association with other devices through which the OTT connection 2150 passes; the sensors may participate in the measurement procedure by supplying values of the monitored quantities exemplified above, or by supplying values of other physical quantities from which software may compute or estimate the monitored quantities. The reconfiguring of the OTT connection 2150 may include message format, retransmission settings, preferred routing, etc.; the reconfiguring need not directly alter the operation of the network node 2104. Such procedures and functionalities may be known and practiced in the art. In certain embodiments, measurements may involve proprietary UE signaling that facilitates measurements of throughput, propagation times, latency, and the like by the host 2102. The measurements may be implemented in that software causes messages to be transmitted, in particular empty or ‘dummy’ messages, using the OTT connection 2150 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

### Group A Embodiments

Embodiment 1: A method performed by a User Equipment, UE, the method comprising:
receiving (1506), from a network node, a downlink reference signal configuration that configures two or more reference signal resource groups, wherein each reference signal resource group of the two or more reference signal resource groups comprises two or more reference signal resources;
performing (1512) measurements on reference signals within the two or more reference signal resource groups, wherein, for each reference signal resource group of the two or more reference signal resource groups:
   different receive, Rx, beams are used for the two or more reference signal resources comprised in the reference signal resource group; and
   each of the different Rx beams used for the two or more reference signal resources comprised in the reference signal resource group is associated to one of two or more UE panels of the UE;
based on the measurements, reporting (1514), to the network node, M beam groups wherein, for each beam group of the M beam groups:
   the beam group indicates one reference signal resource from each of at least a subset of the two or more reference signal resource groups; and
   UE panels associated to the Rx beams used for the reference signal resources indicated by the beam group can be used for:
      simultaneous transmission (e.g., for simultaneous multi-TRP uplink transmission),
      simultaneous reception (e.g., for simultaneous multi-TRP downlink reception), or
      both simultaneous transmission and simultaneous reception.

Embodiment 2: The method of embodiment 1 further comprising transmitting (1504), to the network node, capability information that comprises an indication that the UE supports group-based beam reporting for simultaneous multi-panel uplink transmission.

Embodiment 3: The method of any of embodiments 2 wherein the capability information further comprises:
(a) information that indicates a number of UE panels at the UE;
(b) information that indicates which UE panels can be used for simultaneous uplink transmission,
(c) information that indicates which UE panels can be used for simultaneous downlink reception,
(d) information that indicates which UE panels can be used for simultaneous uplink transmission and simultaneous downlink reception, or
(e) a combination of any two or more of (a)-(c).

Embodiment 4: The method of any of embodiments 2 or 3 wherein the capability information further comprises, for each UE panel of the two or more UE panels of the UE:
(a) information that indicates which other UE panel(s) can be used together with the UE panel for simultaneous uplink transmission,
(b) information that indicates which other UE panel(s) can be used together with the UE panel for simultaneous downlink reception,
(c) information that indicates which other UE panel(s) can be used together with the UE panel for simultaneous uplink transmission and simultaneous downlink reception, or
(d) a combination of any two or more of (a)-(c).

Embodiment 5: The method of any of embodiments 2 to 4 wherein the capability information comprises a bitfield that indicates which UE panels can be used for simultaneous uplink transmission and/or simultaneous downlink reception, wherein each bit of the bitfield is associated with a set (e.g., pair) of UE panels.

Embodiment 6: The method of any of embodiments 1 to 5 further comprising receiving (1508), from the network node, a report configuration associated to the downlink reference signal configuration.

Embodiment 7: The method of embodiment 6 wherein the report configuration comprises a report setting field.

Embodiment 8: The method of embodiment 6 or 7 wherein the report configuration (e.g., the report setting field) indicates that the is to perform group-based beam reporting for STxMP.

Embodiment 9: The method of any of embodiments 6 to 8 wherein the report configuration (e.g., the report setting field) comprises an indication that the UE is to use a first spatial filter when receiving a first reference signal in a reported pair of reference signals, and a second spatial filter when receiving a second reference signal in the reported pair of reference signals, and where the first and second spatial filters are associated with a same or different UE panels.

Embodiment 10: The method of any of embodiments 6 to 8 wherein the report configuration (e.g., the report setting field) comprises an indication that the UE is to use a first spatial filter when receiving a first reference signal in a reported pair of reference signals, and a second spatial filter when receiving a second reference signal in the reported pair of reference signals, and where the first and second spatial filters are not be associated with a same UE panel.

Embodiment 11: The method of any of embodiments 6 to 8 wherein the report configuration (e.g., the report setting field) comprises an indication that the UE is to use a first spatial filter when receiving a first reference signal in a reported pair of reference signals, and a second spatial filter when receiving a second reference signal in the reported pair of reference signals, and where the first and second spatial filters are not associated with the same UE panel and where the two different UE panels can be used for simultaneous transmission.

Embodiment 12: The method of any of embodiments 6 to 8 wherein the report configuration (e.g., the report setting field) comprises information that configures the UE to include, in the report, an indication of the UE panel (e.g., UE panel ID, virtual UE panel ID, UE capability values set) associated with each of reported reference signal resource in each of the M beam groups.

Embodiment 13: The method of any of embodiments 6 to 8 wherein the report configuration (e.g., the report setting field) comprises an indication that the UE is to report if a first UE panel associated with a first reported reference signal in a reported beam group and a second UE panel associated with a second reported reference signal in the same reported beam group can be used for simultaneous UL transmission or not.

Embodiment 14: The method of any of embodiments 6 to 8 wherein the report configuration (e.g., the report setting field) comprises an indication that the UE is to report if a first UE panel associated with a first reported reference signal resource in a reported beam group and a second UE panel associated with a second reported reference signal resource in the same reported beam pair can be used for simultaneous UL transmission, simultaneous DL reception, both simultaneous UL transmission and simultaneous DL reception, or neither simultaneous UL transmission nor simultaneous DL transmission.

Embodiment 15: The method of any of embodiments 6 to 8 wherein the report configuration (e.g., the report setting field) comprises an indication of which of the three candidate options that the UE should assume for the report, i.e. the UE can be configured to follow one of: (a) UE panels associated to the Rx beams used for the reference signal resources indicated by the beam group can be used for simultaneous UL transmission, (b) UE panels associated to the Rx beams used for the reference signal resources indicated by the beam group can be used for simultaneous DL reception, or (c) UE panels associated to the Rx beams used for the reference signal resources indicated by the beam group can be used for both simultaneous UL transmission and simultaneous DL reception.

Embodiment 16: The method of any of embodiments 6 to 15 further comprising receiving (1510) a trigger message that initiates the performing (1512) of the measurements in accordance with the report configuration.

Embodiment 17: The method of any of embodiments 1 to 16 wherein reporting (1514) the M beam groups comprises sending a respective report to the network node.

Embodiment 18: The method of embodiment 17 wherein the report further comprises a performance metric for each reported reference signal resource for each of the M beam groups.

Embodiment 19: The method of embodiment 18 wherein the performance metric indicates uplink performance.

Embodiment 20: The method of embodiment 18 wherein the performance metric indicates downlink reference signal received power+uplink power factor.

Embodiment 21: The method of embodiment 20 wherein the uplink power factor is associated with the UE panel that was used to receive the associated reference signal.

Embodiment 22: The method of embodiment 21 wherein the uplink power factor considers either or both of: (i) P-MPR associated with the UE panel and (ii) maximum available output power associated with the UE panel.

Embodiment 23: The method of any of embodiments 17 wherein the report further comprises information that indicates the UE panel associated with each reported reference signal resource for each of the M beam groups.

Embodiment 24: The method of any of embodiments 17 wherein the report further comprises, for each reported set of reference signal resources for each of the M beam groups, information that indicates that different Rx beams were used for reception of associated reference signals for each of the set of reference signal resources.

Embodiment 25: The method of any of embodiments 17 wherein the report further comprises, for each reported set of reference signal resources for each of the M beam groups, information that indicates that different Rx beams were used for reception of associated reference signals for each of the set of reference signal resources and the associated UE panels can be used for simultaneous uplink transmission.

Embodiment 26: The method of any of embodiments 17 wherein the report further comprises, for each reported set of reference signal resources for each of the M beam groups, information that indicates that different Rx beams were used for reception of associated reference signals for each of the set of reference signal resources and the associated UE panels can be used for simultaneous downlink reception.

Embodiment 27: The method of any of the previous embodiments, further comprising: providing user data and forwarding the user data to a host via the transmission to the network node.

### Group B Embodiments

Embodiment 28: A method performed by a network node, the method comprising:
sending (1506), to a UE, a downlink reference signal configuration that configures two or more reference signal resource groups, wherein each reference signal resource group of the two or more reference signal resource groups comprises two or more reference signal resources;
receiving (1514), from the UE, a report of M beam groups wherein, for each beam group of the M beam groups:
   the beam group indicates one reference signal resource from each of at least a subset of the two or more reference signal resource groups; and
   UE panels associated to Rx beams used for the reference signal resources indicated by the beam group can be used for:
      simultaneous transmission (e.g., for simultaneous multi-TRP uplink transmission),
      simultaneous reception (e.g., for simultaneous multi-TRP downlink reception), or
      both simultaneous transmission and simultaneous reception.

Embodiment 29: The method embodiment 28 further comprising performing one or more actions based on the report.

Embodiment 30: The method of any of the previous embodiments, further comprising: obtaining user data and forwarding the user data to a host or a user equipment.

### Group C Embodiments

Embodiment 31: A user equipment comprising:
processing circuitry configured to perform any of the steps of any of the Group A embodiments; and
power supply circuitry configured to supply power to the processing circuitry.

Embodiment 32: A network node comprising:
processing circuitry configured to perform any of the steps of any of the Group B embodiments;
power supply circuitry configured to supply power to the processing circuitry.

Embodiment 33: A user equipment (UE) comprising:
an antenna configured to send and receive wireless signals;
radio front-end circuitry connected to the antenna and to processing circuitry, and configured to condition signals communicated between the antenna and the processing circuitry;
the processing circuitry being configured to perform any of the steps of any of the Group A embodiments;
an input interface connected to the processing circuitry and configured to allow input of information into the UE to be processed by the processing circuitry;
an output interface connected to the processing circuitry and configured to output information from the UE that has been processed by the processing circuitry; and
a battery connected to the processing circuitry and configured to supply power to the UE.

Embodiment 34: A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of the Group A embodiments to receive the user data from the host.

Embodiment 35: The host of the previous embodiment, wherein the cellular network further includes a network node configured to communicate with the UE to transmit the user data to the UE from the host.

Embodiment 36: The host of the previous 2 embodiments, wherein:
the processing circuitry of the host is configured to execute a host application, thereby providing the user data; and
the host application is configured to interact with a client application executing on the UE, the client application being associated with the host application.

Embodiment 37: A method implemented by a host operating in a communication system that further includes a network node and a user equipment (UE), the method comprising:
providing user data for the UE; and
initiating a transmission carrying the user data to the UE via a cellular network comprising the network node, wherein the UE performs any of the operations of any of the Group A embodiments to receive the user data from the host.

Embodiment 38: The method of the previous embodiment, further comprising: at the host, executing a host application associated with a client application executing on the UE to receive the user data from the UE.

Embodiment 39: The method of the previous embodiment, further comprising:
at the host, transmitting input data to the client application executing on the UE, the input data being provided by executing the host application,
wherein the user data is provided by the client application in response to the input data from the host application.

Embodiment 40: A host configured to operate in a communication system to provide an over-the-top (OTT) service, the host comprising:
processing circuitry configured to provide user data; and
a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of the Group A embodiments to transmit the user data to the host.

Embodiment 41: The host of the previous embodiment, wherein the cellular network further includes a network node configured to communicate with the UE to transmit the user data from the UE to the host.

Embodiment 42: The host of the previous 2 embodiments, wherein:
the processing circuitry of the host is configured to execute a host application, thereby providing the user data; and
the host application is configured to interact with a client application executing on the UE, the client application being associated with the host application.

Embodiment 43: A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.

Embodiment 44: The method of the previous embodiment, further comprising: at the host, executing a host application associated with a client application executing on the UE to receive the user data from the UE.

Embodiment 45: The method of the previous embodiment, further comprising:
at the host, transmitting input data to the client application executing on the UE, the input data being provided by executing the host application,
wherein the user data is provided by the client application in response to the input data from the host application.

Embodiment 46: A host configured to operate in a communication system to provide an over-the-top (OTT) service, the host comprising:
processing circuitry configured to provide user data; and
a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

Embodiment 47: The host of the previous embodiment, wherein:
the processing circuitry of the host is configured to execute a host application that provides the user data; and
the UE comprises processing circuitry configured to execute a client application associated with the host application to receive the transmission of user data from the host.

Embodiment 48: A method implemented in a host configured to operate in a communication system that further includes a network node and a user equipment (UE), the method comprising:
providing user data for the UE; and
initiating a transmission carrying the user data to the UE via a cellular network comprising the network node, wherein the network node performs any of the operations of any of the Group B embodiments to transmit the user data from the host to the UE.

Embodiment 49: The method of the previous embodiment, further comprising, at the network node, transmitting the user data provided by the host for the UE.

Embodiment 50: The method of any of the previous 2 embodiments, wherein the user data is provided at the host by executing a host application that interacts with a client application executing on the UE, the client application being associated with the host application.

Embodiment 51: A communication system configured to provide an over-the-top service, the communication system comprising:
a host comprising:
processing circuitry configured to provide user data for a user equipment (UE), the user data being associated with the over-the-top service; and
a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

Embodiment 52: The communication system of the previous embodiment, further comprising:
the network node; and/or
the user equipment.

Embodiment 53: A host configured to operate in a communication system to provide an over-the-top (OTT) service, the host comprising:
processing circuitry configured to initiate receipt of user data; and
a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

Embodiment 54: The host of the previous 2 embodiments, wherein:
the processing circuitry of the host is configured to execute a host application, thereby providing the user data; and
the host application is configured to interact with a client application executing on the UE, the client application being associated with the host application.

Embodiment 55: The host of the any of the previous 2 embodiments, wherein the initiating receipt of the user data comprises requesting the user data.

Embodiment 56: A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.

Embodiment 57: The method of the previous embodiment, further comprising at the network node, transmitting the received user data to the host.

Those skilled in the art will recognize improvements and modifications to the embodiments of the present disclosure. All such improvements and modifications are considered within the scope of the concepts disclosed herein.

1. A method performed by a User Equipment, UE, the method comprising:
receiving, from a network node, a downlink reference signal configuration that configures a first and a second reference signal resource group;
performing measurements on reference signals within the first and the second reference signal resource groups;
based on the measurements, sending, to the network node, a group-based beam report comprising information for M beam groups wherein, for each beam group of the M beam groups:
the information for the beam group indicates a first reference signal resource from the first resource group and a second reference signal resource from the second resource group wherein the first reference signal is associated with a first spatial filter and the second reference signal is associated with a second spatial filter; and
the first and the second spatial filters can be used for:
simultaneous transmission,
or
both simultaneous transmission and simultaneous reception.

2. The method of claim 1 wherein the first spatial filter is associated with a first UE panel, and the second spatial filter is associated with a second UE panel.

3. The method of claim 1 further comprising:
receiving, from the network node, a report configuration associated to the downlink reference signal configuration, the report configuration comprising a field that indicates that the UE is to perform group-based beam reporting for Simultaneous Multi-Panel Transmission, STxMP;
wherein, responsive to the field that indicates that the UE is to perform group-based beam reporting for STxMP, the UE assumes that, for each beam group of the M beam groups, the UE is to only include the first and the second reference signal resources that are respectively associated with the first and the second spatial filters that can be used for simultaneous transmission, or for both simultaneous transmission and simultaneous reception.

4. The method of claim 1 further comprising:
receiving, from the network node, a report configuration associated to the downlink reference signal configuration, the report configuration comprising a field that indicates that the UE is to perform group-based beam reporting for Simultaneous Multi-Panel Transmission, STxMP;
wherein, responsive to the field that indicates that the UE is to perform group-based beam reporting for STxMP:
for each beam group of the M beam groups, the first and the second spatial filters used respectively for the first and the second reference signal resources indicated by the beam group can be used for simultaneous transmission.

5. (canceled)

6. The method of claim 1 further comprising:
receiving, from the network node, a report configuration associated to the downlink reference signal configuration, the report configuration comprising a field that indicates that the UE is to perform group-based beam reporting for Simultaneous Multi-Panel Transmission, STxMP;
wherein, responsive to the field that indicates that the UE is to perform group-based beam reporting for STxMP:
for each beam group of the M beam groups, the first and the second spatial filters used respectively for the first and the second reference signal resources indicated by the beam group can be used for both simultaneous transmission and simultaneous reception.

7. The method of claim 1 further comprising transmitting, to the network node, capability information that comprises an indication that the UE supports group-based beam reporting for simultaneous multi-panel uplink transmission.

8. The method of claim 1 wherein the capability information further comprises:
(a) information that indicates a number of UE panels at the UE;
(b) information that indicates which UE panels can be used for simultaneous uplink transmission,
(c) information that indicates which UE panels can be used for simultaneous downlink reception,
(d) information that indicates which UE panels can be used for simultaneous uplink transmission and simultaneous downlink reception, or
(e) a combination of any two or more of (a)-(c),
wherein the capability information further comprises, for each UE panel of the two or more UE panels of the UE:
(a) information that indicates which other UE panel(s) can be used together with the UE panel for simultaneous uplink transmission,
(b) information that indicates which other UE panel(s) can be used together with the UE panel for simultaneous downlink reception,
(c) information that indicates which other UE panel(s) can be used together with the UE panel for simultaneous uplink transmission and simultaneous downlink reception, or
(d) a combination of any two or more of (a)-(c).

9. (canceled)

10. The method of claim 7 wherein the capability information comprises a bitfield that indicates which UE panels can be used for simultaneous uplink transmission and/or simultaneous downlink reception, wherein each bit of the bitfield is associated with a set of UE panels.

11. The method of claim 1 further comprising receiving, from the network node, a report configuration associated to a downlink reference signal configuration wherein the report configuration comprises a report setting field.

12. (canceled)

13. (canceled)

14. The method of claim 11 wherein, for a reference signal resource group from among the first and the second reference signal resource groups, the report configuration comprises an indication that the UE is to use the first spatial filter when receiving the first reference signal in the first reference signal resource group, and the second spatial filter when receiving the second reference signal in the second reference signal resource group.

15-16. (canceled)

17. The method of claim 11 wherein the report configuration comprises information that configures the UE to include, in the group-based beam report, an indication of the UE panel associated with each reference signal resource reported in each of the M beam groups.

18. (canceled)

19. The method of claim 11 wherein the report configuration comprises an indication that the UE is to report information that indicates whether a first UE panel associated with the first reported reference signal resource in a reported beam group and a second UE panel associated with the second reported reference signal resource in the same reported beam group can be used for simultaneous transmission, simultaneous reception, both simultaneous transmission and simultaneous reception, or neither simultaneous transmission nor simultaneous transmission.

20. The method of claim 11 wherein the report configuration comprises an indication of which of multiple candidate options that the UE should assume for the group-based beam report wherein the multiple candidate options comprise: (a) UE panels associated to the spatial filters used for the reference signal resources indicated by the same beam group can be used for simultaneous transmission, (b) UE panels associated to the spatial filters used for the reference signal resources indicated by the same beam group can be used for simultaneous reception, or (c) UE panels associated to the spatial filters used for the reference signal resources indicated by the same beam group can be used for both simultaneous UL transmission and simultaneous DL reception.

21-31. (canceled)

32. A User Equipment, UE, adapted to:
receive, from a network node, a downlink reference signal configuration that configures a first and a second reference signal resource group,
perform measurements on reference signals within the first and the second reference signal resource groups;
based on the measurements, send, to the network node, a group-based beam report comprising information for M beam groups wherein, for each beam group of the M beam groups:
the information for the beam group indicates a first reference signal resource from the first resource group and a second reference signal resource from the second resource group wherein the first reference signal is associated with a first spatial filter and the second reference signal is associated with a second spatial filter; and
the first and the second spatial filters can be used for:
simultaneous transmission,
or
both simultaneous transmission and simultaneous reception.

33-35. (canceled)

36. A method performed by a network node, the method comprising:
sending, to a User Equipment, UE, a downlink reference signal configuration that configures a first and a second reference signal resource group,
receiving, from the UE, a group-based beam report comprising information for M beam groups wherein, for each beam group of the M beam groups:
the information for the beam group indicates a first reference signal resource from the first resource group and a second reference signal resource from the second resource group wherein the first reference signal is associated with a first spatial filter and the second reference signal is associated with a second spatial filter; and
the first and the second spatial filters can be used for:
simultaneous transmission,
or
both simultaneous transmission and simultaneous reception.

37. The method claim 36 further comprising performing one or more actions based on the group-based beam report.

38. The method of claim 36 further comprising:
sending, to the UE, a report configuration associated to the downlink reference signal configuration, the report configuration comprising a field that indicates that the UE is to perform group-based beam reporting for Simultaneous Multi-Panel Transmission, STxMP;
wherein, responsive to the field that indicates that the UE is to perform group-based beam reporting for STxMP, the UE is to assume that, for each beam group of the M beam groups, the UE is to only include the first and the second reference signal resources that are respectively associated with the first and the second spatial filters that can be used for simultaneous transmission, or simultaneous transmission and simultaneous reception.

39. The method of claim 36 further comprising:
sending, to the UE, a report configuration associated to the downlink reference signal configuration, the report configuration comprising a field that indicates that the UE is to perform group-based beam reporting for Simultaneous Multi-Panel Transmission, STxMP;
wherein, responsive to the field that indicates that the UE is to perform group-based beam reporting for STxMP:
for each beam group of the M beam groups, the first and the second spatial filters used respectively for the first and the second reference signal resources indicated by the beam group can be used for simultaneous transmission.

40. (canceled)

41. The method of claim 36 further comprising:
sending, to the UE, a report configuration associated to the downlink reference signal configuration, the report configuration comprising a field that indicates that the UE is to perform group-based beam reporting for Simultaneous Multi-Panel Transmission, STxMP;
wherein, responsive to the field that indicates that the UE is to perform group-based beam reporting for STxMP:
for each beam group of the M beam groups, the first and the second spatial filters used respectively for the first and the second reference signal resources indicated by the beam group can be used for both simultaneous transmission and simultaneous reception.

42-45. (canceled)
